(19) United States
(12) Patent Application Publication
(10) Pub. No.: US 2003/0232682 A1
(43) Pub. Date: Dec. 18, 2003

(54) Automatic variable ratio differential

(76) Inventors: William D. Rogers, Bentley, LA (US); Richard D. Rogers, Bentley, LA (US)

Correspondence Address: Allen Darden, P.O. Box 4412, Baton Rouge, LA, 70821-4412, US

(21) Appl. No.: 10/388,786

(22) Filed: Mar. 14, 2003

Related U.S. Application Data
(63) Continuation of application No. 09/622,607, filed on Dec. 28, 2000, now abandoned.
Application No. 09/622,607 is a 371 of international application No. PCT/US98/20711, filed on Oct. 2, 1998.
(60) Provisional application No. 60/075,233, filed on Feb. 19, 1998.

(51) Int. Cl. F16H 48/06

(52) U.S. Cl. 475/221

(57) ABSTRACT

The Automatic Variable Ratio Differential is a multi-purpose device which represents a substantial improvement over current vehicle differential technology. Its primary use is as an improved vehicle differential, allowing the driving wheels to rotate at different speeds when the vehicle is turning. The improvement over the standard differential becomes evident when one of the driving wheels is slipping due to mud or ice; then, the AVRD uses a true mechanical ratio to channel the available torque to the driving wheel with traction, thereby preventing the vehicle from becoming stuck. This device is much more efficient, durable, and powerful than the conventional friction driven limited-slip differentials currently available. In many configurations, the device can also improve the maneuverability and turning-radius of a vehicle by allowing the inside wheel in a turn to rotate in reverse while the outside wheel rotates forward. This produces a force-couple on the vehicle, allowing for a much improved turning-radius. In other configurations, the device can function as a vehicle transmission.

### TECHNICAL FIELD

This invention represents an advance in the field of vehicle differentials which transmit driving torque from the engine to the driving wheels. It allows the driving wheels to rotate at different speeds when the vehicle is in a turn so that the wheels each travel the proper distance, and automatically senses and adjusts the torque sent to each driving wheel.

### BACKGROUND ART

This invention generally relates to the use of a group of torque-sensing and speed-sensing differential devices in combination to produce a true mechanical ratio for proportioning torque between the driving wheels of a vehicle. Although the present invention is in no sense limited to use with the axles of motor vehicles, the herein illustrated forms which the invention may take are particularly adapted for use in motor vehicles. For this reason, the objects and advantages hereinafter disclosed will have specific reference to motor vehicles, but such objects and advantages are intended to extend to other types of construction wherein any one of the desired characteristics of the automatic variable ratio differential would be advantageous.

The purpose of a differential in motor vehicles is to transmit power to the driving wheels while allowing the driving wheels to spin at different speeds. Originally in the development of motor vehicles, the driving wheels were connected to a single, solid axle. This design, however, proved flawed because, although it did transmit the power effectively to the drive wheels, it forced the drive wheels to spin at the same speed. This is precisely the desired result when the vehicle is traveling in a straight forward direction. Unfortunately, a solid axle causes problems when the vehicle turns. In a turn, the inside wheels (those on the side towards which the vehicle is turning) do not travel as far as the outside wheels; this is simply a function of the arcs that the different wheels must travel. If the wheels are joined by a single, solid axle, then there must be scuffing and dragging on the wheels to account for this difference in the distances that they must travel. This wears the tires of the vehicle, produces stress in the axle, and results in a less comfortable ride for the passengers inside the vehicle.

An open differential is the conventional way to overcome this problem. This means that there are two independent axles (one for each drive wheel) connected together by a system of gears known as an open differential. The purpose of the open differential is to allow the two driving axles to rotate at different speeds while still receiving power from the engine. The result of the open differential is a much better ride: when the vehicle is traveling straight forward, the open differential acts as if it were locked, and the two axles rotate as one, but when the vehicle turns, the open differential allows the two axles to spin at different speeds (with the outside axle spinning faster than the inside axle) so that the wheels each travel the correct distance.

Unfortunately, the open differential has problems of its own. Because of the manner in which it allows the two axles to spin at different speeds, the open differential can sometimes result in the vehicle becoming stuck. The open differential always sends equal torque to each of the driving wheels. The amount of torque that it can send is limited based on the minimum tractive force available at the wheels. Thus, when one of the wheels slips (such as when a wheel is on ice or in mud) and there is not much tractive force, the vehicle can not move forwards even if the other wheel has very good traction because the open differential will not transmit enough torque. In such instances, a vehicle without an open differential (a single, solid axle) would not be stuck because the torque transmitted to the driving wheel with traction would not be limited by the lack of traction under the other wheel. But, in vehicles with an open differential, the wheel without traction would spin very quickly as it slipped while the wheel with traction would sit motionless as it does not receive enough torque to move the vehicle forward.

There are devices available to help deal with this functional flaw in an open differential. The simplest way to overcome this problem is to employ a locking mechanism that will link the two independent axles together so that they function as a single, solid drive axle. In effect, this device allows the driver to turn off the open differential in situations where it will function to prevent forward motion. Such a device, however, is cumbersome in size and weight and is slow in action, usually requiring the vehicle to be stopped before the locking can occur. Another attempt to solve the slipping-wheel problem in an open differential is a limited-slip differential. This device in essence is an open differential with a friction device that provides resistance to an axle that is slipping in order to simulate tractive force on the slipping wheel or a differential designed using inefficient gears so that the device always transmits some torque to a wheel with traction. The problem with these limited-slip devices is that they are inefficient and they wear out fairly quickly.

The Automatic Variable Ratio Differential (AVRD) solves the slipping-wheel problem in a more efficient way. It uses an open differential in conjunction with either fixed differentials or planetary gear sets. The result is that the AVRD allows the two drive axles to rotate at different speeds so that it performs the function of a standard open differential when the vehicle is in motion (the axles act as one when the vehicle goes straight but, when the vehicle turns, the outside axle spins faster than the inside axle) but it also prevents the vehicle from being stuck when one wheel is slipping by channeling torque to the wheel with traction. The AVRD accomplishes this by sending the wheel with traction a multiple of the torque that the slipping wheel can handle (based on the tractive force). If the slipping wheel has absolutely no tractive force, then the wheel with traction will not get any torque (since a multiple of zero is still zero), but if there is any tractive force at all (and there always is in the real world even if the coefficient of friction is low), then the wheel with traction will receive much more torque than that available to the slipping wheel. The AVRD channels torque based upon the conditions it senses from the ground-link. Thus, the AVRD channels the available driving power to the location where it is most effective by using a true mechanical ratio.

In some configurations, the AVRD also has the added benefit of providing a tighter turning radius. This improved maneuverability results from the ability of some AVRD configurations to create an inside reverse. Thus, the inner wheel in a turn will rotate backwards as the outer wheel continues to rotate forwards. The result is a force couple acting on the vehicle, and this allows the vehicle to turn rapidly.

### DISCLOSURE OF INVENTION

The AVRD uses a standard open differential in conjunction with either fixed differentials or planetary gear sets to achieve its objectives. There are several different types of standard open differentials, including spur gear types, bevel gear types, and planetary types and also including limited slip differentials, but they all act similarly to produce identical results. A standard open differential gear system divides the torque of a rotational prime mover between the two axle shafts of a vehicle and allows them to rotate at different speeds when turning corners. There are several different configurations, but they generally involve the use of a ring gear, some planet gears, a differential carrier, and two output gears which connect to shafts. Basically, the prime mover provides the input to the differential through the drive shaft pinion. The ring gear (or other rotary input device), which also acts as the differential carrier of the open differential, is driven by the drive shaft pinion. Thus, the differential carrier, which generally houses the open differential gears, rotates at the speed of the ring gear. The planet gears are mounted on stub-shafts fixed to the differential carrier and orbit the output shaft axis at the same speed as the ring gear. When used in the ordinary manner, the output side gears of the differential are connected to the driving axles, which are subsequently connected to the drive wheels of the vehicle. Thus, when the vehicle is traveling in a straight line, the two output side gears (and thus the two axles) revolve at the same speed and there is no relative motion between the planet gears and the two output gears. The planet gears do not rotate on their stub shafts, serving only to transmit motion from the planet carrier to both wheels.

When the vehicle is making a turn, the inside wheel makes fewer revolutions than the outside wheel because of its shorter turning radius. If this difference in speed between the two wheels were not compensated for in some way, one or both of the wheels would have to slide to make the turn. The differential allows the wheels to rotate at different rotational speeds while at the same time delivering power to both. While in a turn, the planet gears rotate on their stub-shafts and permit the output side gears (and thus the axles) to revolve at different speeds relative to one another.

It can easily be seen that if one output shaft is stopped, the other will rotate at twice the speed of the ring gear; this is because the differential carrier (which is attached to the ring gear) rotates at the average speed of the two output shafts. The differential's purpose is to differentiate between the speeds of the two wheels. In the usual automobile differential, the torque is divided equally no matter whether the car is moving in a straight line or not. Often road conditions are such that the tractive effort that can be developed by the two wheels is unequal. When this happens, the total tractive effort available will be only twice that of the wheel having the least traction, because the differential divides the torque equally. Should one wheel be resting on snow or ice, the total effort available is very small and only a small amount of torque will cause the wheel to spin. In a standard open differential, the planet pinions serve as balance levers between output gears. The teeth have an involute profile; the normals to the profiles at all points of contact pass through the pitch points, so the lever arms always remain equal: thus the differential is always in balance.

Both the fixed differential (also known as an hypocycle) and the planetary gear set (also known as an epicycle) produce a single output that is a function of multiple inputs. There are several different types of fixed differentials or hypocycles (using different types of gears), but the most common use spur gears, annular gears, or bevel gears. All fixed differentials function similarly, with the most common arrangement having an input shaft attached to one gear (either spur, annular, or bevel) and an output shaft attached to the other gear (which is of the same type as the first). These two gears (the input gear and the output gear) are parallel, facially adjacent, and do not contact each other. The input gear and the output gear are linked by one or more planetary gears which orbit both the input and the output gears and tangentially contact both the input gear and the output gear. Generally, the input gear and the output gear differ in size (the number of teeth) to produce a gear ratio. Also, the planet gears can serve as an input into the fixed differential when they are connected to a driving member.

The planetary or epicyclic gear train gets its name from the resemblance to our solar system. A planetary gear set always includes a sun gear located in the center of the planetary gear set, one or more planet gears orbiting the sun gear, and a planet carrier or arm which links the planet gears. Often, it also includes an annular gear which encompasses the whole. Fundamentally, a planetary is a special type of epicyclic gear train in which one of the axes of gears may be in motion. The gear train discussed herein may be either simple or compound depending on the configuration of the planet member itself If the planet gear has two different gear faces, it is said to be a compound planetary. The theory of operation of the two types is the same, but generally the compound type is used for larger reduction ratios. Planetaries can be used in the design of computing mechanisms to predict a single output by summing two inputs to provide a single output.

A planetary gear set or fixed differential has two degrees of freedom. This means that the motion of each element of the mechanism is not defined unless the motion of two of its elements is specified. The important feature here is that the output is always the function of two inputs. During operation the inputs sometimes operate as outputs and outputs sometimes operate as inputs as in the case of an overrunning condition where the vehicle wheels are being driven instead of doing the driving (such as engine braking, in such cases there may be torque reversals within the system without changes in direction of rotation.) Generally, an AVRD is made by connecting a fixed differential or planetary gear set on each side of an open differential. There are several different ways that the components of an AVRD can be connected, with each producing some variation in the output, but basically the two variable outputs of the open differential are connected one to each of the planetary gear sets or fixed differentials (the open differential output can be used to drive any of the components of the planetary gear set or fixed differential) and the differential carrier is used as a second input into each planetary gear set or fixed differential. The effect is to allow for a variable ratio which produces the multiplying effect (channeling a multiple of the amount of torque available on the wheel that spins faster to the slower moving wheel so that the wheel with better traction gets more of the driving power from the engine). Thus, the system mechanically proportions torque according to the AVRD's phase shifts. A phase shift is the ability of the epicycle (fixed differential) or hypocycle (planetary sets) to operate concurrently (use multiple inputs), allowing the system of the Automatic Variable Ratio Differential to internally hesitate, stop, reverse, and create a source of motion, such as is introduced by the planet gear of the fixed differential (or planetary set) when the carrier revolves faster (or slower) than an axle sun gear, planetary carrier etc. This has the effect of varying the number of teeth in the sun or annular gears. This can affect the speed (ratio), torque, and internal direction of motion. This amounts to an infinitely variable (in torque and speed) pair of transmissions which operate complimentary to the standard open differential and to each other, to proportion both speed and torque (horsepower) between the wheels of a vehicle in response to variations in ground conditions.

There are multiple inputs into the Automatic Variable Ratio Differential. Any one or any combination of these inputs responds instantly to changes in relative speed among themselves, and causes the gear system to change phase relationship. Since the governing factor in this system is the path of least resistance, the corrections of torque and speed respond to changes in ground conditions as experienced separately by the tires and communicated to the system by the ground link of the two tires in a cooperative fashion.

A phase shift occurs in the system each time a driven gear changes its relative pitch diameter by increase of speed in the same relative direction as its prime mover (losing relative size) or slowing, stopping or reversing (gaining relative size) and vice versa. This is a process which resembles slippage, but does not slip.

It is this process which causes the system to seek the wheel which has traction and can accept the bulk of carrier torque and place it there at a reduced RPM, then begin to search for the maximum speed at which the wheel with traction can accept horsepower, even as it cooperates with changing ground conditions at the tire that was slipping, by communicating with the prime mover through the ground link.

The advantages of the automatic variable ratio differential are substantial. AVRDs perform the function of a standard differential (allowing the two drive axles to act as one when the vehicle is moving straight forward while allowing the two axles to spin at different speeds when the vehicle is turning) while eliminating the drawback of a vehicle becoming stuck when one wheel loses traction even when the other wheel does have traction. It channels torque to the wheel with traction so that the wheel with traction can pull the vehicle with multiples of the torque available to the slipping wheel. When the AVRD is used in conjunction with a brake that provides resistance to the slipping wheel axle, the wheel with traction can receive a great deal of torque due to the multiplying effect of the AVRD. The AVRD principle can also be used in the transfer case for a four-wheel-drive vehicle to improve the torque distribution to all four wheels. The AVRD also distributes torque shock throughout the system so that the axles can better handle the stresses. In addition, the AVRD can reduce the turning radius of a vehicle in certain configurations. This reduced turning radius results from the ability of some AVRD configurations to produce a reversing action on one wheel while the other continues forward. This produces a force couple which is a more effective means of turning. Also, because AVRDs prevent tire slippage and skidding, they reduce both tire wear and damage to the tire-surface interface. Additionally, in some configurations, AVRDs can act as a transmission for a vehicle. Finally, it should be noted that the principles of the AVRD can be used in devices other than vehicles. It can be used any time that multiple outputs are needed but several individual motors are impractical due to size constraints.

### BRIEF DESCRIPTION OF THE DRAWINGS

Reference will be made to drawings wherein like parts in each preferred embodiment are designated by like numerals and wherein each figure illustrates a different preferred embodiment of the automatic variable ratio differential as described below.

FIG. 1 is a schematic of an embodiment of an AVRD.

FIG. 2 is a schematic of an embodiment of an AVRD.

FIG. 3 is a schematic of an embodiment of an AVRD.

FIG. 4 is a schematic of an embodiment of an AVRD.

FIG. 5 is a schematic of an embodiment of an AVRD.

FIG. 6 is a schematic of an embodiment of an AVRD.

FIG. 7 is a schematic of an embodiment of an AVRD.

FIG. 8 is a schematic of an embodiment of an AVRD.

FIG. 9 is a schematic of an embodiment of an AVRD.

FIG. 10 is a schematic of an embodiment of an AVRD.

FIG. 11 is a schematic of an embodiment of an AVRD.

FIG. 12 is a schematic of an embodiment of an AVRD.

FIG. 13 is a schematic of an embodiment of an AVRD.

FIG. 14 is a schematic of an embodiment of an AVRD.

FIG. 15 is a schematic of an embodiment of an AVRD.

FIG. 16 is a schematic of an embodiment of an AVRD which acts as a transmission.

FIG. 17 is a schematic of an embodiment of an AVRD which acts as a transmission.

### BEST MODES FOR CARRYING OUT THE INVENTION

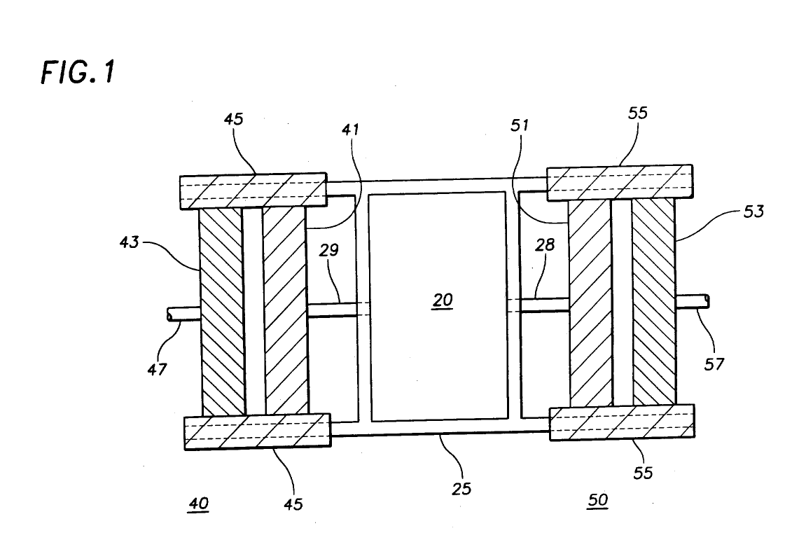

There are several different arrangements for the Automatic Variable Ratio Differential. The drawings are schematics which detail the several preferred embodiments. The size of each of the gears for any preferred embodiment will depend upon the use for which the device is designed, with the gear ratio being set according to the responsiveness of torque proportioning required for a particular use. Referring now to the drawings in detail, the first preferred embodiment of the AVRD is shown in the schematic labeled FIG. 1. This embodiment is comprised of an open differential 20 and two fixed differentials 40 and 50. The input from the motor (not shown in the schematic) directs driving torque into the open differential 20. On one side of the open differential 20, the open differential output 29 is rigidly attached to the inner gear 41 of the fixed differential 40 (typically this is a spur type of gear, an annular type of gear, or a bevel type of gear). Facially adjacent to but not contacting the inner gear 41 is the outer gear 43 (which is the same type of gear as the inner gear 41). The outer gear 43 has more teeth than does the inner gear 41 of the fixed differential 40. One or more planet gears 45 link the inner gear 41 and the outer gear 43 of open differential 40 by tangentially contacting both the inner gear 41 and the outer gear 43 with intermeshing teeth. Typically, there are two or three planet gears 45 spaced evenly about the gears that they contact (inner gear 41 and outer gear 43). Each of the planet gears 45 which tangentially contact the inner gear 41 and outer gear 43 in fixed differential 40 may vary in size along its length such that its diameter at the point of contact with the inner gear 41 is different than its diameter at the point of contact with the outer gear 43 in order to accommodate the difference in the number of teeth and in order to alter the ratio of the fixed differential 40. The one or more planet gears 45 are rigidly attached to the open differential carrier 25. If there are multiple planet gears 45 in fixed differential 40, then the positions of the planet gears 45 are fixed relative to one another and relative to the open differential carrier 25 while allowing each planet gear 45 to rotate about its own center axis. If there is only one planet gear 45 in fixed differential 40, then its position is fixed relative to the open differential carrier 25 while it is allowed to rotate about its center axis, and it is held in contact with the inner gear 41 and outer gear 43. The fixed differential output 47 (which typically is an axle leading to a wheel) is rigidly attached to the outer gear 43 of the open differential 40.

The other side of the AVRD is a mirror image of that described above. The open differential output 28 is rigidly attached to the inner gear 51 of the fixed differential 50 (typically this is a spur type of gear, an annular type of gear, or a bevel type of gear). Facially adjacent to but not contacting the inner gear 51 is the outer gear 53 (which is the same type of gear as the inner gear 51). The outer gear 53 has more teeth than does the inner gear 51 of the fixed differential 50. One or more planet gears 55 link the inner gear 51 and the outer gear 53 of open differential 50 by tangentially contacting both the inner gear 51 and the outer gear 53 with intermeshing teeth. Typically, there are two or three planet gears 55 spaced evenly around the gears that they contact (inner gear 51 and outer gear 53). Each of the planet gears 55 which tangentially contact the inner gear 51 and outer gear 53 in fixed differential 50 may vary in size along its length such that its diameter at the point of contact with the inner gear 51 is different than its diameter at the point of contact with the outer gear 53 in order to accommodate the difference in the number of teeth and in order to alter the ratio of the fixed differential 50. The one or more planet gears 55 are rigidly attached to the open differential carrier 25. Thus, if there are a plurality of planet gears 55, then the positions of the planet gears 55 are fixed relative to one another and relative to the open differential carrier 25 while allowing each planet gear 55 to rotate about its own center axis. If there is only one planet gear 55 in fixed differential 50, then its position is fixed relative to the open differential carrier 25 while it is allowed to rotate about its center axis, and it is held in contact with the inner gear 51 and outer gear 53. The fixed differential output 57 (which typically is an axle leading to a wheel) is rigidly attached to the outer gear 53 of the open differential 50.

When the vehicle is traveling straight forward and both driving wheels have equal traction, the gears in both fixed differentials 40 and 50 act as though locked, and the entire AVRD rotates as a whole unit. If there is slipping, however, the gears in fixed differentials 40 and 50 will rotate relative to one another to channel the torque to the wheel with better traction. In this situation, the planet gears 45 in fixed differential 40 rotate around the center axis of fixed differential 40 at a different speed than the inner gear 41, and so the planet gears 45 orbit the inner gear 41. The outer gear 43 is simultaneously orbited by the planet gears 45. Thus, the rotation and torque of the fixed differential output 47 is modified from the open differential output 29 by the relative motion of the planet gears 45 with respect to the inner gear 41 and by the difference in the number of teeth between inner gear 41 and outer gear 43. Fixed differential 50 behaves similarly. The planet gears 55 in fixed differential 50 rotate around the center axis of fixed differential 50 at a different speed than the inner gear 51, and so the planet gears 55 orbit the inner gear 51. The outer gear 53 is simultaneously orbited by the planet gears 55. Thus, the rotation and torque of the fixed differential output 57 is modified from the open differential output 28 by the relative motion of the planet gears 55 with respect to the inner gear 51 and by the difference in the number of teeth between inner gear 51 and outer gear 53. When the AVRD functions as a whole, the driving torque coming into the open differential 20 is channeled to the wheel with better traction, with that wheel receiving a multiple of the torque that the slipping wheel can receive.

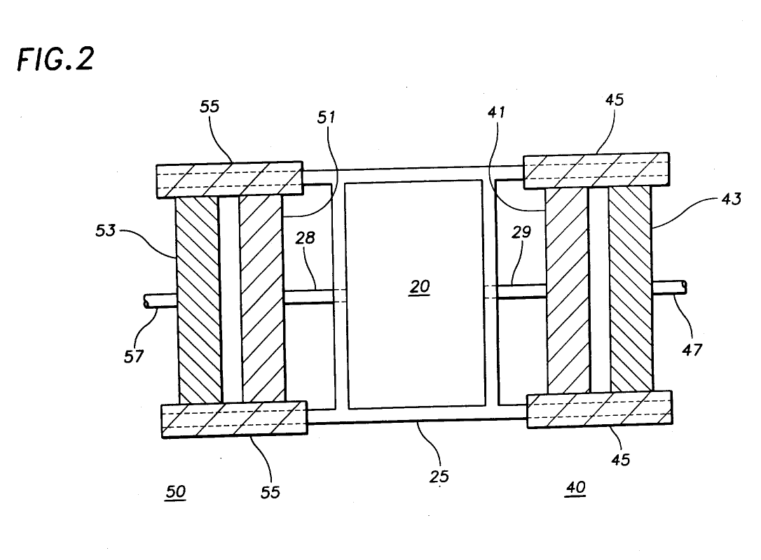

Another preferred embodiment of the AVRD is shown in the schematic labeled FIG. 2. This embodiment is comprised of an open differential 20 and two fixed differentials 40 and 50. The input from the motor (not shown in the schematic) directs driving torque into the open differential 20. On one side of the open differential 20, the open differential output 29 is rigidly attached to the inner gear 41 of the fixed differential 40 (typically this is a spur type of gear, an annular type of gear, or a bevel type of gear). Facially adjacent to but not contacting the inner gear 41 is the outer gear 43 (which is the same type of gear as the inner gear 41). The outer gear 43 has less teeth than does the inner gear 41 of the fixed differential 40. One or more planet gears 45 link the inner gear 41 and the outer gear 43 of open differential 40 by tangentially contacting both the inner gear 41 and the outer gear 43 with intermeshing teeth. Typically, there are two or three planet gears 45 spaced evenly about the gears that they contact (inner gear 41 and outer gear 43). Each of the planet gears 45 which tangentially contact the inner gear 41 and outer gear 43 in fixed differential 40 may vary in size along its length such that its diameter at the point of contact with the inner gear 41 is different than its diameter at the point of contact with the outer gear 43 in order to accommodate the difference in the number of teeth and in order to alter the ratio of the fixed differential 40. The one or more planet gears 45 are rigidly attached to the open differential carrier 25. If there are a plurality of planet gears 45, then the positions of the planet gears 45 are fixed relative to one another and relative to the open differential carrier 25 while allowing each planet gear 45 to rotate about its own center axis. If there is only one planet gear 45 in fixed differential 40, then its position is fixed relative to the open differential carrier 25 while it is allowed to rotate about its center axis, and it is held in contact with the inner gear 41 and outer gear 43. The fixed differential output 47 (which typically is an axle leading to a wheel), is rigidly attached to the outer gear 43 of the open differential 40.

The other side of the AVRD is a mirror image of that described above. The open differential output 28 is rigidly attached to the inner gear 51 of the fixed differential 50 (typically this is a spur type of gear, an annular type of gear, or a bevel type of gear). Facially adjacent to but not contacting the inner gear 51 is the outer gear 53 (which is the same type of gear as the inner gear 51). The outer gear 53 has less teeth than does the inner gear 51 of the fixed differential 50. One or more planet gears 55 link the inner gear 51 and the outer gear 53 of open differential 50 by tangentially contacting both the inner gear 51 and the outer gear 53 with intermeshing teeth. Typically, there are two or three planet gears 55 evenly spaced around the gears that they contact (inner gear 51 and outer gear 53). Each of the planet gears 55 which tangentially contact the inner gear 51 and outer gear 53 in fixed differential 50 may vary in size along its length such that its diameter at the point of contact with the inner gear 51 is different than its diameter at the point of contact with the outer gear 53 in order to accommodate the difference in the number of teeth and in order to alter the ratio of the fixed differential 50. The one or more planet gears 53 are rigidly attached to the open differential carrier 25. If there are a plurality of planet gears 55 in planetary gear set 50, then the positions of the planet gears 55 are fixed relative to one another and relative to the open differential carrier 25 while allowing each planet gear 55 to rotate about its own center axis. If there is only one planet gear 55 in fixed differential 50, then its position is fixed relative to the open differential carrier 25 while it is allowed to rotate about its center axis, and it is held in contact with the inner gear 51 and outer gear 53. The fixed differential output 57 (which typically is an axle leading to a wheel) is rigidly attached to the outer gear 53 of the open differential 50.

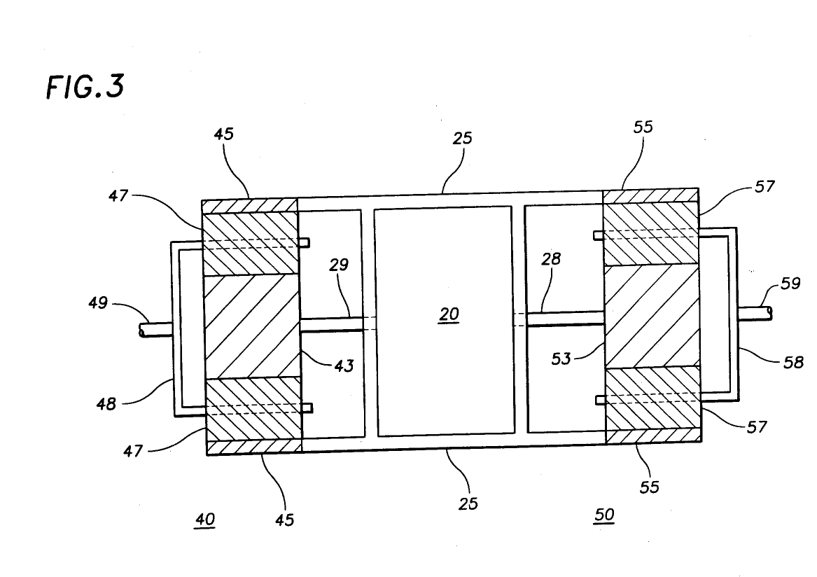

Yet another preferred embodiment is shown in the schematic labeled FIG. 3. This embodiment is comprised of an open differential 20 and two planetary gear sets 40 and 50. The input from the motor (not shown in the schematic) directs driving torque into the open differential 20. On one side of the open differential 20, the open differential output 29 rigidly connects to the sun gear 43 which is located in the center of the planetary gear set 40. The open differential carrier 25 is rigidly attached to the annular gear 45 which encloses the planetary gear set 40. The sun gear 43 and the annular gear 45 are both contacted (with intermeshing teeth) by one or more planet gears 47 which are located between the sun gear 43 and the annular gear 45. Typically, there are two or three planet gears 47 spaced evenly around the sun gear 43. If there are a plurality of planet gears 47, then they are all joined by a planetary carrier 48 which rigidly fixes their positions relative to one another while allowing each planet gear 47 to rotate about its center axis. If there is only one planet gear 47 in planetary gear set 40, then the planetary carrier 48, which appears as a connecting arm, links the single planet gear 47 to the center axis of the planetary gear set 40 in order to hold the planet gear 47 in place while allowing the planet gear 47 to rotate about its center axis. The planetary carrier 48 is rigidly attached to the planetary gear set output 49 for planetary gear set 40.

The other side of the AVRD is a mirror image of the side described above. The open differential output 28 rigidly connects to the sun gear 53 which is located in the center of the planetary gear set 50. The open differential carrier 25 is rigidly attached to the annular gear 55 which encloses the planetary gear set 50. The sun gear 53 and the annular gear 55 are both contacted (with intermeshing teeth) by one or more planet gears 57 which are located between the sun gear 53 and the annular gear 55. Typically, there are two or three planet gears 57 spaced evenly around the sun gear 53. If there are a plurality of planet gears 57, then they are all joined by a planetary carrier 58 which rigidly fixes their positions relative to one another while allowing each planet gear 57 to rotate about its center axis. If there is only one planet gear 57 in planetary gear set 50, then the planetary carrier 58, which appears as a connecting arm, links the single planet gear 57 to the center axis of the planetary gear set 50 in order to hold the planet gear 57 in place while allowing the planet gear 57 to rotate about its center axis. The planetary carrier 58 is rigidly attached to the planetary gear set output 59 for planetary gear set 50.

When the vehicle is traveling straight forward and both driving wheels have equal traction, the gears in both fixed differentials 40 and 50 act as though locked, and the entire AVRD rotates as a whole unit. If there is slipping, however, the gears in fixed differentials 40 and 50 will rotate relative to one another to channel the torque to the wheel with better traction. When this occurs, the planet gears 47 are acted upon by two different forces. The sun gear 43 attempts to pull the planet gears 47 along so that they rotate in step with it, while the annular gear 45 attempts to pull the planet gears 47 along so that they rotate in step with it. The result is that the planet gears 47 rotate as a unit around the center axis of planetary gear set 40 at their own speed and each planet gear 47 rotates about its own center axis to accommodate the difference. Thus, the rotation of the planetary carrier 48 is a function of the interplay between the sun gear 43, the annular gear 45, and the planet gears 47. The behavior of planetary gear set 50 is similar. The planet gears 57 are acted upon by two different forces. The sun gear 53 attempts to pull the planet gears 57 along so that they rotate in step with it, while the annular gear 55 attempts to pull the planet gears 57 along so that they rotate in step with it. The result is that the planet gears 57 rotate as a unit around the center axis of planetary gear set 50 at their own speed and each planet gear 57 rotates about its own center axis to accommodate the difference. Thus, the rotation of the planetary carrier 58 is a function of the interplay between the sun gear 53, the annular gear 55, and the planet gears 57. When the AVRD functions as a unit, the result is that the independent rotational motion of the gears in planetary gear sets 40 and 50 act to set up a ratio that channels the driving torque entering the open differential 20 to the wheel with better traction, sending it multiples of the torque available to the slipping wheel.

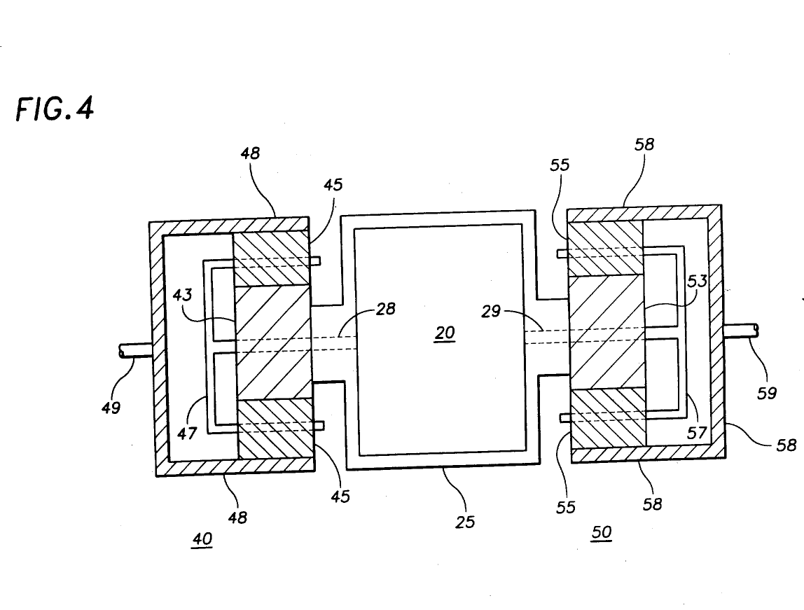

Yet another preferred embodiment is shown in the schematic labeled FIG. 4. This embodiment is comprised of an open differential 20 and two planetary gear sets 40 and 50. The input from the motor (not shown in the schematic) directs driving torque into the open differential 20. On one side of the open differential 20, the sun gear 43 is located in the center of the planetary gear set 40 and is rigidly attached to the open differential carrier 25. One or more planet gears 45 encircle the sun gear 43 and are in contact (with the teeth intermeshing) with the sun gear 43. Typically, there are two or three planet gears 45 spaced evenly around the sun gear 43. If there are a plurality of planet gears 45, then they are rigidly linked by a planetary carrier 47 which fixes the positions of the planet gears 45 relative to one another while allowing each planet gear 45 to rotate about its center axis. If there is only one planet gear 45 in planetary gear set 40, then the planetary carrier 47, which appears as a connecting arm, links the single planet gear 45 to the center axis of the planetary gear set 40 in order to hold the planet gear 45 in place while allowing the planet gear 45 to rotate about its center axis. The open differential output 28 on this side is rigidly attached to the planetary carrier 47. Encompassing the one or more planet gears 45 in this planetary gear set 40 is an annular gear 48. This annular gear 48 makes contact with the one or more planet gears 45 such that the entire planetary gear set 40 is connected by the intermeshing teeth of the sun gear 43 with those on the one or more planet gears 45 and by the intermeshing teeth of the one or more planet gears 45 with those of the annular gear 48. The annular gear 48 is rigidly attached to the planetary gear set output 49 for planetary gear set 40.

The other side of the AVRD is a mirror image of the side described above. The sun gear 53 is located in the center of the planetary gear set 50 and is rigidly attached to the open differential carrier 25. One or more planet gears 55 encircle the sun gear 53 and are in contact (with the teeth intermeshing) with the sun gear 53. Typically, there are two or three planet gears 55 spaced evenly around the sun gear 53. If there are a plurality of planet gears 55, then they are rigidly linked by a planetary carrier 57 which fixes the positions of the planet gears 55 relative to one another while allowing each planet gear 55 to rotate about its center axis. If there is only one planet gear 55 in planetary gear set 50, then the planetary carrier 57, which appears as a connecting arm, links the single planet gear 55 to the center axis of the planetary gear set 50 in order to hold the planet gear 55 in place while allowing the planet gear 55 to rotate about its center axis. The open differential output 29 on this side is rigidly attached to the planetary carrier 57. Encompassing the one or more planet gears 55 in this planetary gear set 50 is an annular gear 58. This annular gear 58 makes contact with the one or more planet gears 55 such that the entire planetary gear set 50 is connected by the intermeshing teeth of the sun gear 53 with those on the one or more planet gears 55 and by the intermeshing teeth of the one or more planet gears 55 with those of the annular gear 58. The annular gear 58 is rigidly attached to the planetary gear set output 59 for planetary gear set 50. This configuration of the AVRD can reduce the turning radius of a vehicle in which an AVRD is installed due to the reactive force when the steering axle is aligned properly. This reduced turning radius results from the ability of this configuration of the AVRD to produce a reversing action on one wheel while the other continues forward.

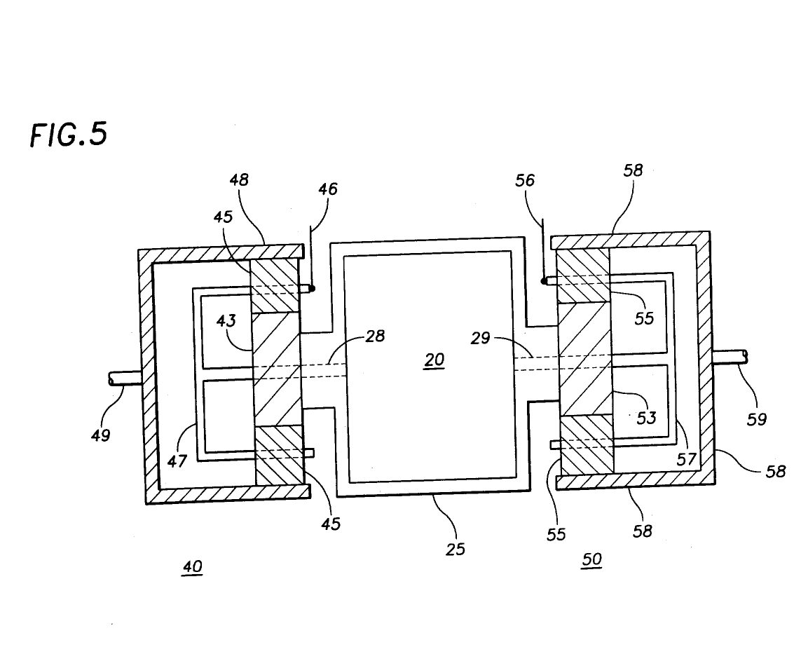

Yet another preferred embodiment is shown in the schematic labeled FIG. 5. This embodiment is identical to that described above for FIG. 4 except that it additionally has a brake attached to each of the planetary carriers of the planetary gear sets. (While the preferred embodiment uses a brake, any type of rotary input may be used to alter the effect of the AVRD. Thus, any time in this document that the term “brake” is used, it is understood that it represents a wide array of possible rotary inputs). If engaged, a brake will act to retard the rotation of the planetary carrier to which it is attached, thereby acting as another input into the planetary gear set and altering the planetary gear set output from that planetary gear set. This embodiment is comprised of an open differential 20 and two planetary gear sets 40 and 50. The input from the motor (not shown in the schematic) directs driving torque into the open differential 20. On one side of the open differential 20, the sun gear 43 is located in the center of the planetary gear set 40 and is rigidly attached to the open differential carrier 25. One or more planet gears 45 encircle the sun gear 43 and are in contact (with the teeth intermeshing) with the sun gear 43. Typically, there are two or three planet gears 45 spaced evenly around the sun gear 43. If there are a plurality of planet gears 45, then they are rigidly linked by a planetary carrier 47 which fixes the positions of the planet gears 45 relative to one another while allowing each planet gear 45 to rotate about its center axis. If there is only one planet gear 45 in planetary gear set 40, then the planetary carrier 47, which appears as a connecting arm, links the single planet gear 45 to the center axis of the planetary gear set 40 in order to hold the planet gear 45 in place while allowing the planet gear 45 to rotate about its center axis. Attached to the planetary carrier 47 is a brake 46 which, when disengaged, does not affect the rotation of the planetary carrier 47, but when engaged, acts to retard the rotation of the planetary carrier 47. The open differential output 28 on this side is rigidly attached to the planetary carrier 47. Encompassing the one or more planet gears 45 in this planetary gear set 40 is an annular gear 48. This annular gear 48 makes contact with the one or more planet gears 45 such that the entire planetary gear set 40 is connected by the intermeshing teeth of the sun gear 43 with those on the one or more planet gears 45 and by the intermeshing teeth of the one or more planet gears 45 with those of the annular gear 48. The annular gear 48 is rigidly attached to the planetary gear set output 49 for planetary gear set 40.

The other side of the AVRD is a mirror image of the side described above. The sun gear 53 is located in the center of the planetary gear set 50 and is rigidly attached to the open differential carrier 25. One or more planet gears 55 encircle the sun gear 53 and are in contact (with the teeth intermeshing) with the sun gear 53. Typically, there are two or three planet gears 53 evenly spaced about the sun gear 53. If there are a plurality of planet gears 55, then they are rigidly linked by a planetary carrier 57 which fixes the positions of the planet gears 55 relative to one another while allowing each planet gear 55 to rotate about its center axis. If there is only one planet gear 55 in planetary gear set 50, then the planetary carrier 57, which appears as a connecting arm, links the single planet gear 55 to the center axis of the planetary gear set 50 in order to hold the planet gear 55 in place while allowing the planet gear 55 to rotate about its center axis. A brake 56 is attached to the planetary carrier 57 such that, when disengaged, it does not affect the rotation of the planetary carrier 57, but when engaged, it acts to retard the rotation of the planetary carrier 57. The open differential output 29 on this side is rigidly attached to the planetary carrier 57. Encompassing the one or more planet gears 55 in this planetary gear set 50 is an annular gear 58. This annular gear 58 makes contact with the one or more planet gears 55 such that the entire planetary gear set 50 is connected by the intermeshing teeth of the sun gear 53 with those on the one or more planet gears 55 and by the intermeshing teeth of the one or more planet gears 55 with those of the annular gear 58. The annular gear 58 is rigidly attached to the planetary gear set output 59 for planetary gear set 50. This configuration of the AVRD can reduce the turning radius of a vehicle in which an AVRD is installed due to the application of brakes. This reduced turning radius results from the ability of this configuration of the AVRD to produce a reversing action on one wheel while the other continues forward.

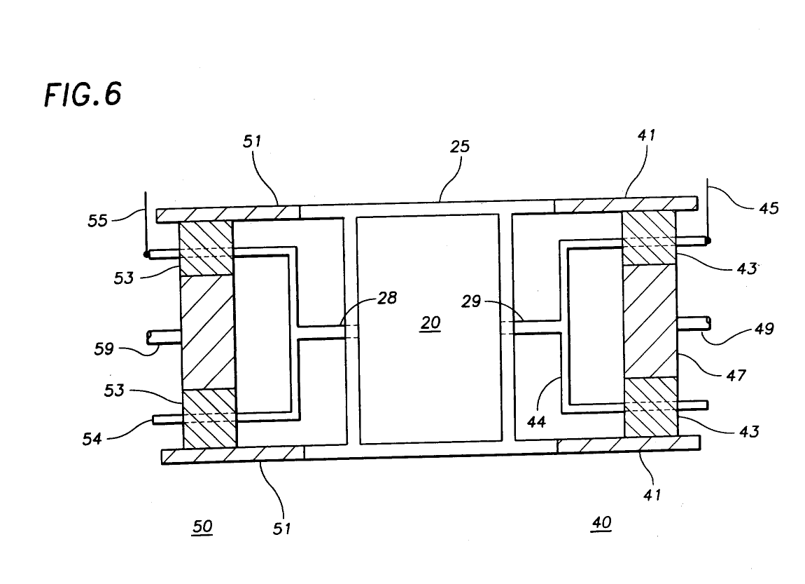

Yet another preferred embodiment is shown in the schematic labeled FIG. 6. This embodiment is comprised of an open differential 20 and two planetary gear sets 40 and 50. The input from the motor (not shown in the schematic) directs driving torque into the open differential 20. On one side of the open differential 20, the open differential carrier 25 is rigidly attached to the annular gear 41 of the planetary gear set 40. In contact with the inner circumference of the annular gear 41 are one or more planet gears 43. Typically there are two or three planet gears 43 spaced evenly around the annular gear's 41 inner circumference. The teeth of the one or more planet gears 43 intermesh with those of the annular gear 41. If there are a plurality of planet gears 43, then they are rigidly linked together by a planetary carrier 44 which fixes the position of the planet gears 43 relative to one another while allowing each planet gear 43 to rotate about its center axis. If there is only one planet gear 43 in planetary gear set 40, then the planetary carrier 44, which appears as a connecting arm, links the single planet gear 43 to the center axis of the planetary gear set 40 in order to hold the planet gear 43 in place while allowing the planet gear 43 to rotate about its center axis. The open differential output 29 on this side of the open differential 20 is rigidly attached to the planetary carrier 44 of the planetary gear set 40. Also attached to the planetary carrier 44 is a brake 45 which, when disengaged, does not affect the rotation of the planetary carrier 44 but, when engaged, acts to retard the rotation of the planetary carrier 44. Located centrally in the planetary gear set 40 is the sun gear 47. The sun gear 47 is encircled and contacted by the one or more planet gears 43 such that the teeth of the sun gear 47 intermesh with those of the one or more planet gears 43 which are located around the circumference of the sun gear 47. Thus, the planetary gear set 40 is made whole such that the motions of the components are interrelated due to the intermeshing of the teeth of the annular gear 41 with those of the one or more planet gears 43 and the intermeshing of the teeth of the one or more planet gears 43 with those of the sun gear 47. The sun gear 47 is rigidly attached to the planetary gear set output 49 for planetary gear set 40.

The other side of the AVRD is a mirror image of the side described above. The open differential carrier 25 is rigidly attached to the annular gear 51 of the planetary gear set 50. In contact with the inner circumference of the annular gear 51 are one or more planet gears 53. Typically there are two or three planet gears 53 spaced evenly around the annular gear's 51 inner circumference. The teeth of the one or more planet gears 53 intermesh with those of the annular gear 51. If there are a plurality of planet gears 53, then they are rigidly linked together by a planetary carrier 54 which fixes the position of the planet gears 53 relative to one another while allowing each planet gear 53 to rotate about its center axis. If there is only one planet gear 53 in planetary gear set 50, then the planetary carrier 54, which appears as a connecting arm, links the single planet gear 53 to the center axis of the planetary gear set 50 in order to hold the planet gear 53 in place while allowing the planet gear 53 to rotate about its center axis. The open differential output 28 on this side of the open differential 20 is rigidly attached to the planetary carrier 54 of the planetary gear set 50. Also attached to the planetary carrier 54 is a brake 55 which, when disengaged, does not affect the rotation of the planetary carrier 54 but, when engaged, acts to retard the rotation of the planetary carrier 54. Located centrally in the planetary gear set 50 is the sun gear 57. The sun gear 57 is encircled and contacted by the one or more planet gears 53 such that the teeth of the sun gear 57 intermesh with those of the one or more planet gears 53 which are located around the circumference of the sun gear 57. Thus, the planetary gear set 50 is made whole such that the motions of the components are interrelated due to the intermeshing of the teeth of the annular gear 51 with those of the one or more planet gears 53 and the intermeshing of the teeth of the one or more planet gears 53 with those of the sun gear 57. The sun gear 57 is rigidly attached to the planetary gear set output 59 for planetary gear set 50. This configuration of the AVRD can reduce the turning radius of a vehicle in which an AVRD is installed due to the application of brakes. This reduced turning radius results from the ability of this configuration of the AVRD to produce a reversing action on one wheel while the other continues forward.

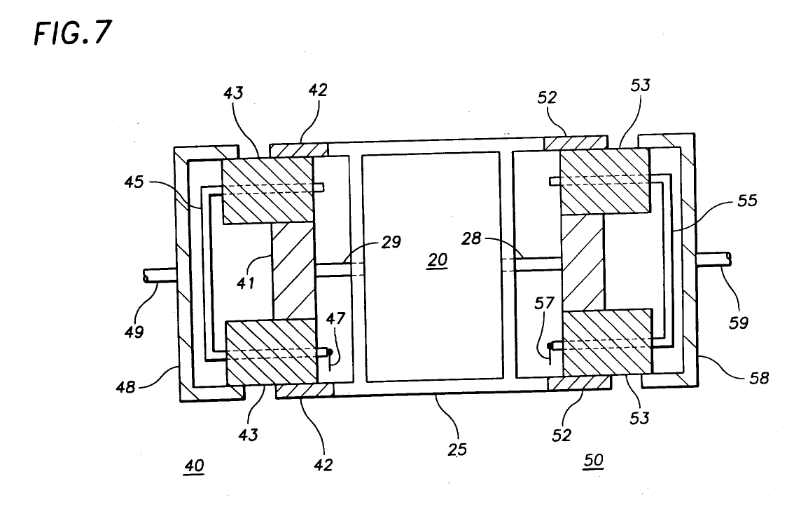

Yet another preferred embodiment is shown in the schematic labeled FIG. 7. This embodiment is comprised of an open differential 20 and two planetary gear sets 40 and 50. The input from the motor (not shown in the schematic) directs driving torque into the open differential 20. On one side, the open differential output 29 rigidly attaches to the sun gear 41 which is located at the center of the planetary gear set 40. The inner annular gear 42 of the planetary gear set 40 is rigidly attached to the open differential carrier 25 (and surrounds the sun gear 41, leaving space between them for the one or more planetary gears 43). Located between and in contact (with intermeshing teeth) with the inner annular gear 42 and the sun gear 41 of the planetary gear set 40 are one or more planet gears 43. Typically, there are two or more planet gears 43 evenly spaced surrounding the sun gear 41. These one or more planet gears 43 extend out farther length-wise away from the open differential 20 than does the inner annular gear 42. If there are a plurality of planet gears 43, then they are rigidly linked by a planetary carrier 45 which fixes the position of the planet gears 43 relative to one another while allowing each planet gear 43 to rotate freely about its center axis. If there is only one planet gear 43 in planetary gear set 40, then the planetary carrier 45, which appears as a connecting arm, links the single planet gear 43 to the center axis of the planetary gear set 40 in order to hold the planet gear 43 in place while allowing the planet gear 43 to rotate about its center axis. A brake 47 is attached to the planetary carrier 45 of this planetary gear set 40 such that, when the brake 47 is engaged, it will retard the rotation of the planetary carrier 45, but when the brake 47 is disengaged, it will have no affect on the rotation of the planetary carrier 45. Located facially adjacent to but not making contact with the inner annular gear 42 of planetary gear set 40 is the outer annular gear 48. Typically, the outer annular gear 48 has a different number of teeth than the inner annular gear 42, and the one or more planet gears 43 which link them vary in size such that they have one diameter when contacting the inner annular gear 42 and a different diameter when contacting the outer annular gear 48. The outer annular gear 48 contacts (with intermeshing teeth) the one or more planet gears 43 in this planetary gear set 40 on the portion of each of the planet gears 43 which extends beyond the inner annular gear 42. The outer annular gear 48 is rigidly connected to the planetary gear set output 49 of planetary gear set 40.

The other side of the AVRD is a mirror image of that described above. The open differential output 28 rigidly attaches to the sun gear 51 which is located at the center of the planetary gear set 50. The inner annular gear 52 of the planetary gear set 50 is rigidly attached to the open differential carrier 25 (and surrounds the sun gear 51, leaving space between them for the one or more planet gears 53). Located between and in contact (with intermeshing teeth) with the inner annular gear 52 and the sun gear 51 of the planetary gear set 50 are one or more planet gears 53. Typically, there are two or three planet gears 53 evenly spaced surrounding the sun gear 51. These one or more planet gears 53 extend out farther length-wise away from the open differential 20 than does the inner annular gear 52. If there are a plurality of planet gears 53, then they are rigidly linked by a planetary carrier 55 which fixes the position of the planet gears 53 relative to one another while allowing each planet gear 53 to rotate freely about its center axis. If there is only one planet gear 53 in planetary gear set 50, then the planetary carrier 55, which appears as a connecting arm, links the single planet gear 53 to the center axis of the planetary gear set 50 in order to hold the planet gear 53 in place while allowing the planet gear 53 to rotate about its center axis. A brake 57 is attached to the planetary carrier 55 of this planetary gear set 50 such that, when the brake 57 is engaged, it will retard the rotation of the planetary carrier 55, but when the brake 57 is disengaged, it will have no affect on the rotation of the planetary carrier 55. Located facially adjacent to but not making contact with the inner annular gear 52 of planetary gear set 50 is the outer annular gear 58. Typically, the outer annular gear 58 has a different number of teeth than the inner annular gear 52, and the one or more planet gears 53 which link them vary in size so that they have one diameter when contacting the inner annular gear 52 and a different diameter when contacting the outer annular gear 58. The outer annular gear 58 contacts (with intermeshing teeth) the one or more planet gears 53 in this planetary gear set 50 on the portion of each of the planet gears 53 which extends beyond the inner annular gear 52. The outer annular gear 58 is rigidly connected to the planetary gear set output 59 of planetary gear set 50. This configuration of the AVRD can reduce the turning radius of a vehicle in which an AVRD is installed due to the application of brakes. This reduced turning radius results from the ability of this configuration of the AVRD to produce a reversing action on one wheel while the other continues forward.

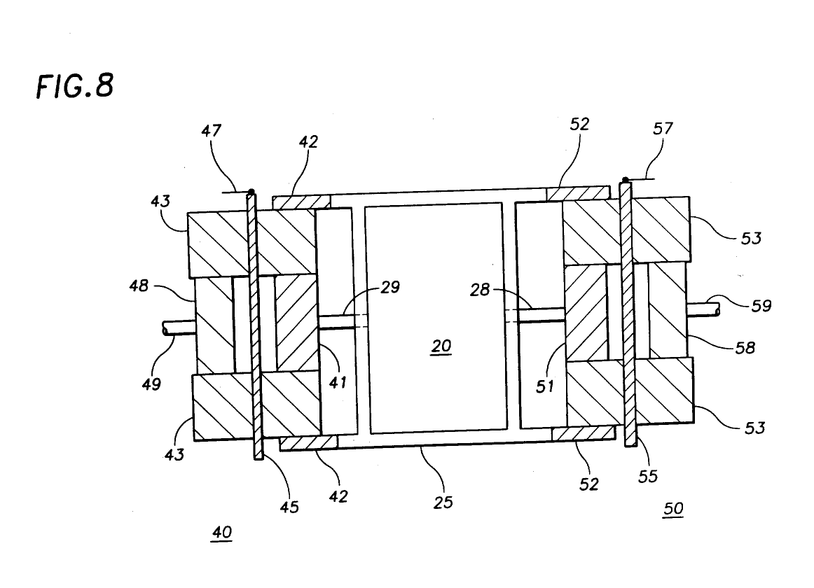

Yet another preferred embodiment is shown in the schematic labeled FIG. 8. This embodiment is comprised of an open differential 20 and two planetary gear sets 40 and 50. The input from the motor (not shown in the schematic) directs driving torque into the open differential 20. On one side of the open differential 20, the open differential output 29 is rigidly attached to the inner sun gear 41 which is located at the center of the planetary gear set 40. The annular gear 42 acts to enclose the planetary gear set 40 and is rigidly attached to the open differential carrier 25. Located between and in contact with the inner sun gear 41 and the annular gear 42 of the planetary set 40 are one or more planet gears 43. There are typically two or three planet gears 43 spaced evenly around the inner sun gear 41. If there are a plurality of planet gears 43, then they are rigidly linked by a planetary carrier 45 which fixes the position of the planet gears 43 relative to one another while allowing each planet gear 43 to rotate about its own center axis. If there is only one planet gear 43 in planetary gear set 40, then the planetary carrier 45, which appears as a connecting arm, links the single planet gear 43 to the center axis of the planetary gear set 40 in order to hold the planet gear 43 in place while allowing the planet gear 43 to rotate about its center axis. In FIG. 8, the planetary carrier 45 fixes the position of the planet gears 43 not by connecting the center axes of the planet gears 43 but by locating a portion of the planet gears 43 which is smooth and not covered with teeth within holes in the planetary carrier 45. The one or more planet gears 43 extend out farther lengthwise from the open differential 20 than does the inner sun gear 41. A brake 47 is attached to the planet carrier 45 of the planetary gear set 40 such that, when the brake 47 is disengaged, it does not affect the motion of the planetary carrier 45, but when the brake 47 is engaged, it acts to retard the rotation of the planetary carrier 45. Located facially adjacent to but not making contact with the inner sun gear 41 of the planetary gear set 40 is the outer sun gear 48. Typically, the outer sun gear 48 differs in size from the inner sun gear 41, and the one or more planet gears 43 each vary in size such that their diameter when contacting the inner sun gear 41 is different than their diameter when contacting the outer sun gear 48 so that the size difference between the inner sun gear 41 and the outer sun gear 48 can be accommodated. The outer sun gear 48 contacts (with intermeshing teeth) the one or more planet gears 43 in this planetary gear set 40 on the portion of each of the planet gears 43 which extends beyond the inner sun gear 41. It should be noted that the diameter of the one or more planet gears 43 may vary along their length so that the planet gears 43 mesh well with both the inner sun gear 41 and the outer sun gear 48 of the planetary gear set 40 even when the inner sun gear 41 and the outer sun gear 48 are sized differently (have different numbers of teeth). The outer sun gear 48 of the planetary gear set 40 is rigidly attached to the planetary gear set output 49 of the planetary gear set 40.

The other side of the AVRD is a mirror image of the side described above. The open differential output 28 is rigidly attached to the inner sun gear 51 which is located at the center of the planetary gear set 50. The annular gear 52 acts to enclose the planetary gear set 50 and is rigidly attached to the open differential carrier 25. Located between and in contact with the inner sun gear 51 and the annular gear 52 of the planetary set 50 are one or more planet gears 53. There are typically two or three planet gears 53 spaced evenly around the inner sun gear 51. If there are a plurality of planet gears 53, then they are rigidly linked by a planetary carrier 55 which fixes the position of the planet gears 53 relative to one another while allowing each planet gear 53 to rotate about its own center axis. If there is only one planet gear 53 in planetary gear set 50, then the planetary carrier 55, which appears as a connecting arm, links the single planet gear 53 to the center axis of the planetary gear set 50 in order to hold the planet gear 53 in place while allowing the planet gear 53 to rotate about its center axis. In FIG. 8, the planetary carrier 55 fixes the position of the planet gears 53 not by connecting the center axes of the planet gears 53 but by locating a portion of the planet gears 53 which is smooth and not covered with teeth within holes in the planetary carrier 55. The one or more planet gears 53 extend out farther length-wise from the open differential 20 than does the inner sun gear 51. A brake 57 is attached to the planet carrier 55 of the planetary gear set 50 such that, when the brake 57 is disengaged, it does not affect the motion of the planetary carrier 55, but when the brake 57 is engaged, it acts to retard the rotation of the planetary carrier 55. Located facially adjacent to but not making contact with the inner sun gear 51 of the planetary gear set 50 is the outer sun gear 58. Typically, the outer sun gear 58 differs in size from the inner sun gear 51, and the one or more planet gears 53 each vary in size such that their diameter when contacting the inner sun gear 51 is different than their diameter when contacting the outer sun gear 58 so that the size difference between the inner sun gear 51 and the outer sun gear 58 can be accommodated. The outer sun gear 58 contacts (with intermeshing teeth) the one or more planet gears 53 in this planetary gear set 50 on the portion of each of the planet gears 53 which extends beyond the inner sun gear 51. It should be noted that the diameter of the one or more planet gears 53 may vary along their length so that the planet gears 53 mesh well with both the inner sun gear 51 and the outer sun gear 58 of the planetary gear set 50 even when the inner sun gear 51 and the outer sun gear 58 are sized differently (have different numbers of teeth). The outer sun gear 58 of the planetary gear set 50 is rigidly attached to the planetary gear set output 59 of the planetary gear set 50. This configuration of the AVRD can reduce the turning radius of a vehicle in which an AVRD is installed due to the application of brakes. This reduced turning radius results from the ability of this configuration of the AVRD to produce a reversing action on one wheel while the other continues forward.

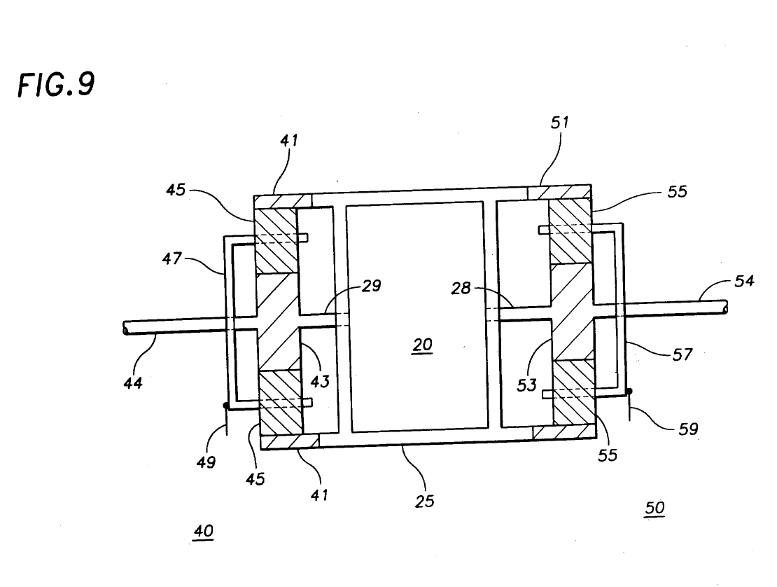

Yet another preferred embodiment is shown in the schematic labeled FIG. 9. This embodiment is comprised of an open differential 20 and two planetary gear sets 40 and 50. The input from the motor (not shown in the schematic) directs driving torque into the open differential 20. On one side of the open differential 20, the open differential carrier 25 is rigidly attached to the annular gear 41 which acts to enclose the planetary gear set 40. Located around the inner circumference of the annular gear 41 and in contact (with teeth intermeshing) with the annular gear 41 are one or more planet gears 45. Typically there are two or three planet gears 45 spaced evenly around the inner circumference of the annular gear 41. If there are a plurality of planet gears 45, then they are rigidly linked together by a planetary carrier 47 which fixes the positions of the planet gears 45 relative to one another while allowing each planet gear 45 to rotate about its center axis. If there is only one planet gear 45 in planetary gear set 40, then the planetary carrier 47, which appears as a connecting arm, links the single planet gear 45 to the center axis of the planetary gear set 40 in order to hold the planet gear 45 in place while allowing the planet gear 45 to rotate about its center axis. A brake 49 is attached to the planetary carrier 47 of the planetary gear set 40 such that, when the brake 49 is disengaged, it has no affect on the rotation of the planet carrier 47, but when the brake 49 is engaged, it acts to retard the rotation of the planetary carrier 47. Located in the center of the planetary gear set 40 and orbited by and in contact with the one or more planet gears 45 is the sun gear 43 of planetary gear set 40. Thus, the planetary gear set 40 is made whole as a unit by the sun gear 43 contacting the one or more planet gears 45 with intermeshing teeth and by the one or more planet gears 45 contacting the annular gear 41 with intermeshing teeth. The sun gear 43 of planetary gear set 40 rigidly attaches to the open differential output 29 and also to the planetary gear set output 44 of planetary gear set 40.

The other side of the AVRD is a mirror image of that described above. The open differential carrier 25 is rigidly attached to the annular gear 51 which acts to enclose the planetary gear set 50. Located around the inner circumference of the annular gear 51 and in contact (with teeth intermeshing) with the annular gear 51 are one or more planet gears 55. Typically, there are two or three planet gears 55 spaced evenly around the inner circumference of the annular gear 51. If there are a plurality of planet gears 55, then they are rigidly linked together by a planetary carrier 57 which fixes the positions of the planet gears 55 relative to one another while allowing each planet gear 55 to rotate about its center axis. If there is only one planet gear 55 in planetary gear set 50, then the planetary carrier 57, which appears as a connecting arm, links the single planet gear 55 to the center axis of the planetary gear set 50 in order to hold the planet gear 55 in place while allowing the planet gear 55 to rotate about its center axis. A brake 59 is attached to the planetary carrier 57 of the planetary gear set 50 such that, when the brake 59 is disengaged, it has no affect on the rotation of the planet carrier 57, but when the brake 59 is engaged, it acts to retard the rotation of the planetary carrier 57. Located in the center of the planetary gear set 50 and orbited by and in contact with the one or more planet gears 55 is the sun gear 53 of planetary gear set 50. Thus, the planetary gear set 50 is made whole as a unit by the sun gear 53 contacting the one or more planet gears 55 with intermeshing teeth and by the one or more planet gears 55 contacting the annular gear 51 with intermeshing teeth. The sun gear 53 of planetary gear set 50 rigidly attaches to the open differential output 28 and also to the planetary gear set output 54 of planetary gear set 50. This configuration of the AVRD can reduce the turning radius of a vehicle in which an AVRD is installed due to the application of brakes. This reduced turning radius results from the ability of this configuration of the AVRD to produce a reversing action on one wheel while the other continues forward.

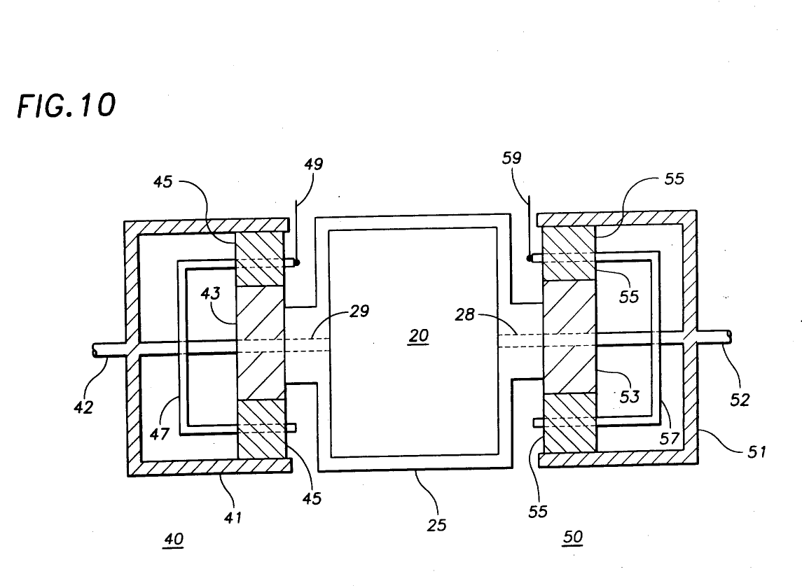

Yet another preferred embodiment is shown in the schematic labeled FIG. 10. This embodiment is comprised of an open differential 20 and two planetary gear sets 40 and 50. The input from the motor (not shown in the schematic) directs driving torque into the open differential 20. On one side, the open differential output 29 rigidly connects to the annular gear 41 of the planetary gear set 40 which rigidly connects to the planetary gear set output 42 of planetary gear set 40. The sun gear 43 is located at the center of planetary gear set 40 and rigidly connects to the open differential carrier 25. Located between and in contact with the annular gear 41 and the sun gear 43 of planetary gear set 40 are one or more planet gears 45 (said contact being the intermeshing of the teeth of the gears). Typically, there are two or three planet gears 45 evenly spaced about the sun gear. If there are a plurality of planet gears 45, then they are rigidly linked together by a planetary carrier 47 which fixes the positions of the planet gears 45 relative to one another while allowing each planet gear 45 to rotate about its center axis. If there is only one planet gear 45 in planetary gear set 40, then the planetary carrier 47, which appears as a connecting arm, links the single planet gear 45 to the center axis of the planetary gear set 40 in order to hold the planet gear 45 in place while allowing the planet gear 45 to rotate about its center axis. A brake 49 attaches to the planetary carrier 47 of planetary gear set 40 such that, when the brake 49 is disengaged, it does not affect the rotation of the planetary carrier 47, but when the brake 49 is engaged, it acts to retard the rotation of the planetary carrier 47.

The other side of the AVRD is a mirror of the side described above. The open differential output 28 rigidly connects to the annular gear 51 of the planetary gear set 50 which rigidly connects to the planetary gear set output 52 of planetary gear set 50. The sun gear 53 is located at the center of planetary gear set 50 and rigidly connects to the open differential carrier 25. Located between and in contact with the annular gear 51 and the sun gear 53 of planetary gear set 50 are one or more planet gears 55 (said contact being the intermeshing of the teeth of the gears). Typically, there are two or three planet gears 55 spaced evenly around the sun gear 53. If there are a plurality of planet gears, then they are rigidly linked together by a planetary carrier 57 which fixes the positions of the planet gears 55 relative to one another while allowing each planet gear 55 to rotate about its center axis. If there is only one planet gear 55 in planetary gear set 50, then the planetary carrier 57, which appears as a connecting arm, links the single planet gear 55 to the center axis of the planetary gear set 50 in order to hold the planet gear 55 in place while allowing the planet gear 55 to rotate about its center axis. A brake 59 attaches to the planetary carrier 57 of planetary gear set 50 such that, when the brake 59 is disengaged, it does not affect the rotation of the planetary carrier 57, but when the brake 59 is engaged, it acts to retard the rotation of the planetary carrier 57. This configuration of the AVRD can reduce the turning radius of a vehicle in which an AVRD is installed due to the application of brakes. This reduced turning radius results from the ability of this configuration of the AVRD to produce a reversing action on one wheel while the other continues forward.

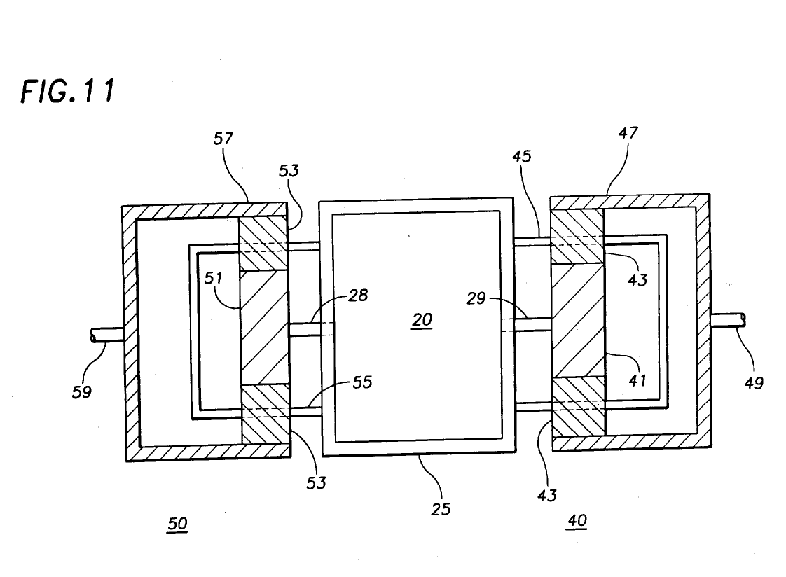

Yet another preferred embodiment of the AVRD is shown in the schematic labeled FIG. 11. This embodiment is comprised of an open differential 20 and two planetary gear sets 40 and 50. The input from the motor (not shown in the schematic) directs driving torque into the open differential 20. On one side of the open differential 20, the open differential output 29 rigidly attaches to the sun gear 41 located at the center of planetary gears set 40. The sun gear 41 is encircled and contacted (with intermeshing teeth) by one or more planet gears 43. Typically, there are two or three planet gears 43 spaced evenly around the sun gear 41. If there are a plurality of planet gears 43 in planetary gear set 40, then they are rigidly linked by the planetary carrier 45 of the planetary gears set 40 which fixes the position of the planet gears 43 relative to one another while allowing each planet gear 43 to rotate about its own center axis. If there is only one planet gear 43 in planetary gear set 40, then the planetary carrier 45, which appears as a connecting arm, links the single planet gear 43 to the center axis of the planetary gear set 40 in order to hold the planet gear 43 in place while allowing the planet gear 43 to rotate about its center axis. The planetary carrier 45 of planetary gear set 40 is rigidly attached to the open differential carrier 25. The one or more planet gears 43 in planetary gear set 40 are encompassed by the annular gear 47 of planetary gear set 40. The annular gear 47 makes contact with the one or more planet gears 43 with intermeshing teeth. Rigidly attached to the annular gear 47 of planetary gear set 40 is the planetary gear set output 49 (most often an axle which leads to a wheel).

The other side of the AVRD mirrors that described above. The open differential output 28 rigidly attaches to the sun gear 51 located at the center of planetary gears set 50. The sun gear 51 is encircled and contacted (with intermeshing teeth) by one or more planet gears 53. Typically, there are two or three planet gears 53 in planetary gear set 50 spaced evenly around the sun gear 51. If there are a plurality of planet gears 53, then they are rigidly linked by the planetary carrier 55 of the planetary gear set 50 which fixes the position of the planet gears 53 relative to one another while allowing each planet gear 53 to rotate about its own center axis. If there is only one planet gear 53 in planetary gear set 50, then the planetary carrier 55, which appears as a connecting arm, links the single planet gear 53 to the center axis of the planetary gear set 50 in order to hold the planet gear 53 in place while allowing the planet gear 53 to rotate about its center axis. The planetary carrier 55 of planetary gear set 50 is rigidly attached to the open differential carrier 25. The one or more planet gears 53 in planetary gear set 50 are encompassed by the annular gear 57 of planetary gear set 50. The annular gear 57 makes contact with the one or more planet gears 53 with intermeshing teeth. Rigidly attached to the annular gear 57 of planetary gear set 50 is the planetary gear set output 59 (most often an axle which leads to a wheel).

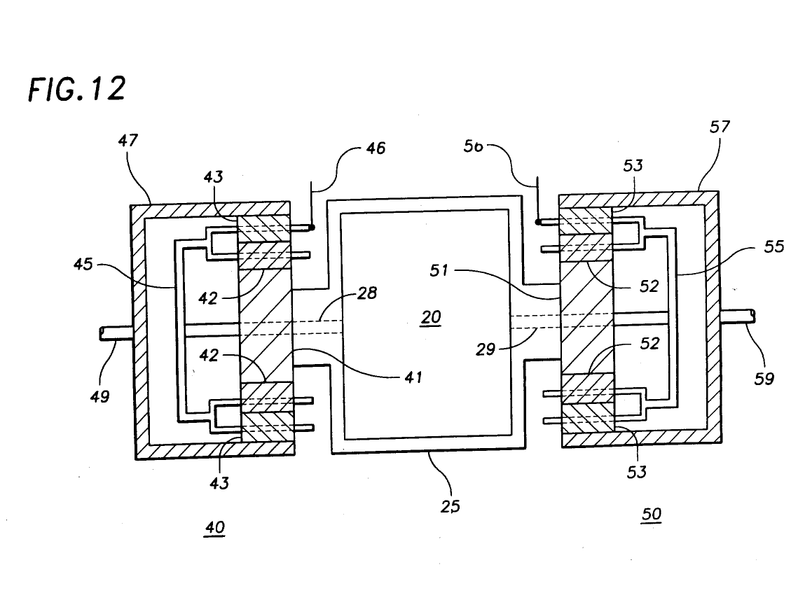

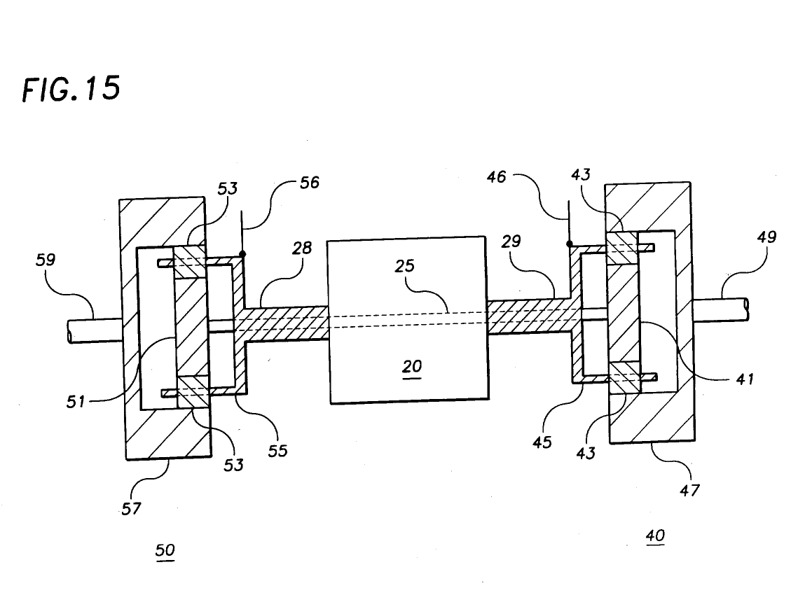

Yet another preferred embodiment of the AVRD is shown in the schematic labeled FIG. 12. It is an example of configurations of the AVRD which use multiple layers of planet gears surrounding the sun gear of the planetary gear set. Any AVRD arrangement could use multiple layers of planet gears in place of a single layer of planet gears, but the preferred embodiment is shown in FIG. 15. This embodiment is comprised of an open differential 20 and two planetary gear sets 40 and 50. The input from the motor (not shown in the schematic) directs driving torque into the open differential 20. On one side of the open differential 20, the sun gear 41 which is located at the center of planetary gear set 40 is rigidly attached to the open differential carrier 25. One or more inner planet gears 42 orbit the sun gear 41 of the planetary gear set 40 and make contact with the sun gear 41 (with intermeshing teeth). Typically there are two or three inner planet gears 42 evenly spaced about the sun gear 41. If there are a plurality of inner planet gears 42, then they are rigidly linked together by a planetary carrier 45 which fixes the position of the plurality of inner planet gears 42 with respect to one another while allowing each inner planet gear 42 to rotate about its center axis. If there is only one inner planet gear 42 in planetary gear set 40, then the planetary carrier 45, which appears as a connecting arm, links the single inner planet gear 42 to the center axis of the planetary gear set 40 in order to hold the inner planet gear 42 in place while allowing the inner planet gear 42 to rotate about its center axis. Located farther outward radially and encircling the one or more inner planet gears 42 are one or more outer planet gears 43. There are the same number of outer planet gears 43 as there are inner planet gears 42 in planetary gear set 40. These outer planet gears 43 contact the inner planet gears 42 (with intermeshing teeth). If there are a plurality of outer planet gears 43 in planetary gear set 40, then they are rigidly linked together by the planet carrier 45 which fixes the position of the outer planet gears 43 relative to one another and relative to the inner planet gears 42 while allowing each outer planet gear 43 to rotate about its own center axis. If there is only one outer planet gear 43 in planetary gear set 40, then the planetary carrier 45, which appears as a connecting arm, links the single outer planet gear 43 to the center axis of the planetary gear set 40 and fixes its position relative to the inner planet gear 42 in order to hold the outer planet gear 43 in place in the planetary gear set 40 while allowing the outer planet gear 43 to rotate about its center axis. A brake 46 attaches to the planet carrier 45 such that, when disengaged, it does not affect the rotation of the planetary carrier 45, but when engaged, it retards the rotation of the planetary carrier 45. The open differential output 28 is rigidly attached to the planetary carrier 45. The annular gear 47 of planetary gear set 40 encompasses the one or more outer planet gears 43, making contact with the outer planet gears 43 with intermeshing teeth. Rigidly attached to the annular gear 47 is the planetary gear set output 49 of planetary gear set 40.

The other side of the AVRD is a mirror image of that described above. The sun gear 51 which is located at the center of planetary gear set 50 is rigidly attached to the open differential carrier 25. One or more inner planet gears 52 encircle the sun gear 51 of the planetary gear set 50 and make contact with the sun gear 51 (with intermeshing teeth). Typically, there are two or three inner planet gears 52 evenly spaced about the sun gear 51. If there are a plurality of inner planet gears 52 in planetary gear set 50, then they are rigidly linked together by aplanetary carrier 55 which fixes the position of the plurality of inner planet gears 52 with respect to one another while allowing each inner planet gear 52 to rotate about its center axis. If there is only one inner planet gear 52 in planetary gear set 50, then the planetary carrier 55, which appears as a connecting arm, links the single inner planet gear 52 to the center axis of the planetary gear set 50 in order to hold the inner planet gear 52 in place while allowing the inner planet gear 42 to rotate about its center axis. Located farther outward radially and orbiting the one or more inner planet gears 52 are one or more outer planet gears 53. There are the same number of outer planet gears 53 in planetary gear set 50 as there are inner planet gears 52. These outer planet gears 53 contact the inner planet gears 52 (with intermeshing teeth). If there are a plurality of outer planet gears 53, then they are rigidly linked together by the planet carrier 55 which fixes the position of the outer planet gears 53 relative to one another and relative to the inner planet gears 52 while allowing each outer planet gear 53 to rotate about its own center axis. If there is only one outer planet gear 53 in planetary gear set 50, then the planetary carrier 55, which appears as a connecting arm, links the single outer planet gear 53 to the center axis of the planetary gear set 50 and fixes its position relative to the inner planet gear 52 in order to hold the outer planet gear 53 in place in the planetary gear set 50 while allowing the outer planet gear 53 to rotate about its center axis. A brake 56 attaches to the planet carrier 55 such that, when disengaged, it does not affect the rotation of the planetary carrier 55, but when engaged, it retards the rotation of the planetary carrier 55. The open differential output 29 is rigidly attached to the planetary carrier 55. The annular gear 57 of planetary gear set 50 encompasses the one or more outer planet gears 53, making contact with the one or more outer planet gears 53 (with intermeshing teeth). Rigidly attached to the annular gear 57 is the planetary gear set output 59 of planetary gear set 50.

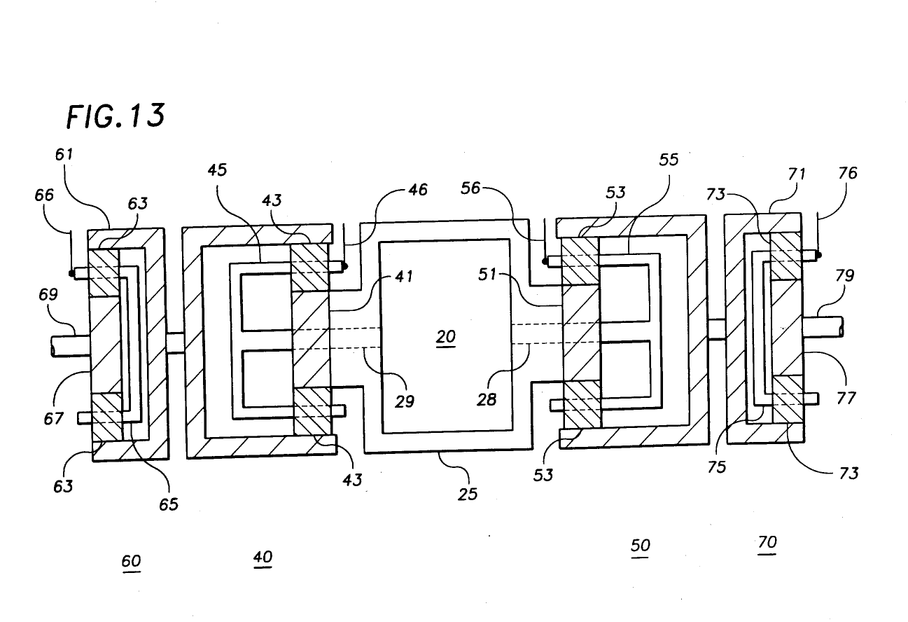

An AVRD can also be constructed using compound planetary gear sets on each side of the open differential. This may be useful when a high ratio is needed. A compound planetary gear setup can be made with any variety of gear connections between the open differential and the multiple planetary gear sets or fixed differentials on each side of the open differential, but the preferred embodiment is shown in the schematic labeled FIG. 13. This embodiment is comprised of an open differential 20 and four planetary gear sets 40, 50, 60, and 70. The input from the motor (not shown in the schematic) directs driving torque into the open differential 20. On one side of the open differential 20, the sun gear 41 located at the center of planetary gear set 40 rigidly attaches to the open differential carrier 25. The sun gear 41 is orbited by one or more planet gears 43 which make contact with the sun gear 41 with intermeshing teeth. Typically, there are two or three planet gears 43 in planetary gear set 40 spaced evenly around the sun gear 41. If there are a plurality of planet gears 43, then they are rigidly linked together by a planetary carrier 45 which fixes the positions of the planet gears 43 relative to one another while allowing each planet gear 43 to rotate about its own center axis. If there is only one planet gear 43 in planetary gear set 40, then the planetary carrier 45, which appears as a connecting arm, links the single planet gear 43 to the center axis of the planetary gear set 40 in order to hold the planet gear 43 in place while allowing the planet gear 43 to rotate about its center axis. A brake 46 attaches to the planetary carrier 45 such that, when the brake 46 is disengaged, it has no affect on the rotation of the planetary carrier 45, but when the brake 46 is engaged, it acts to retard the rotation of the planetary carrier 45. Rigidly attached to the planetary carrier 45 of planetary gear set 40 is the open differential output 29. The annular gear 47 of planetary gear set 40 encompasses the one or more planet gears 43 and contacts the one or more planet gears 43 with intermeshing teeth. Annular gear 47 of planetary gear set 40 is rigidly attached to the annular gear 61 of planetary gear set 60 (the outer planetary gear set on this side). Located around the inner circumference of the annular gear 61 of planetary gear set 60 are one or more planet gears 63. These planet gears 63 make contact with the annular gear 61 with intermeshing teeth. Typically there are two or three planet gears 63 in planetary gear set 60 spaced evenly about the inner circumference of the annular gear 61. If there are a plurality of planet gears 63 in planetary gear set 60, then they are rigidly linked together by the planetary carrier 65 for planetary gear set 60 such that the position of the planet gears 63 are fixed relative to one another while allowing each planet gear 63 to rotate about its own center axis. If there is only one planet gear 63 in planetary gear set 60, then the planetary carrier 65, which appears as a connecting arm, links the single planet gear 63 to the center axis of the planetary gear set 60 in order to hold the planet gear 63 in place while allowing the planet gear 63 to rotate about its center axis. Attached to the planetary carrier 65 of planetary gear set 60 is a brake 66 which, when disengaged, does not affect the rotation of the planetary carrier 65, but when engaged, acts to retard the rotation of the planetary carrier 65 of planetary gear set 60. Located in the center of planetary gear set 60 and orbited by the one or more planet gears 63 is the sun gear 67 of planetary gear set 60. The sun gear 67 contacts the one or more planet gears 63 with intermeshing teeth. Rigidly attached to the sun gear 67 of planetary gear set 60 is the planetary gear set output 69.

The other side of the AVRD is a mirror image of that described above. The sun gear 51 located at the center of planetary gear set 50 rigidly attaches to the open differential carrier 25. The sun gear 51 is encircled by one or more planet gears 53 which make contact with the sun gear 51 with intermeshing teeth. Typically, there are two or three planet gears 53 spaced evenly around the sun gear 51. If there are a plurality of planet gears 53 in planetary gear set 50, then they are rigidly linked together by a planetary carrier 55 which fixes the positions of the planet gears 53 relative to one another while allowing each planet gear 53 to rotate about its own center axis. If there is only one planet gear 53 in planetary gear set 50, then the planetary carrier 55, which appears as a connecting arm, links the single planet gear 53 to the center axis of the planetary gear set 50 in order to hold the planet gear 53 in place while allowing the planet gear 53 to rotate about its center axis. A brake 56 attaches to the planetary carrier 55 such that, when the brake 56 is disengaged, it has no affect on the rotation of the planetary carrier 55, but when the brake 56 is engaged, it acts to retard the rotation of the planetary carrier 55. Rigidly attached to the planetary carrier 55 of planetary gear set 50 is the open differential output 28. The annular gear 57 of planetary gear set 50 encompasses the one or more planet gears 53 and contacts the planet gears 53 with intermeshing teeth. Annular gear 57 of planetary gear set 50 is rigidly attached to the annular gear 71 of planetary gear set 70 (the outer planetary gear set on this side). Located around the inner circumference of the annular gear 71 of planetary gear set 70 are one or more planet gears 73. These planet gears 73 make contact with the annular gear 71 with intermeshing teeth. Typically, there are two or three planet gears 73 spaced evenly about the inner circumference of the annular gear 71. If there are a plurality of planet gears 73 in planetary gear set 70, then they are rigidly linked together by the planetary carrier 75 for planetary gear set 70 such that the position of the planet gears 73 are fixed relative to one another while allowing each planet gear 73 to rotate about its own center axis. If there is only one planet gear 73 in planetary gear set 70, then the planetary carrier 75, which appears as a connecting arm, links the single planet gear 73 to the center axis of the planetary gear set 70 in order to hold the planet gear 73 in place while allowing the planet gear 73 to rotate about its center axis. Attached to the planetary carrier 75 of planetary gear set 70 is a brake 76 which, when disengaged, does not affect the rotation of the planetary carrier 75, but when engaged, acts to retard the rotation of the planetary carrier 75 of planetary gear set 70. Located in the center of planetary gear set 70 and orbited by the one or more planet gears 73 is the sun gear 77 of planetary gear set 70. The sun gear 77 contacts the planet gears 73 with intermeshing teeth. Rigidly attached to the sun gear 77 of planetary gear set 70 is the planetary gear set output 79. This configuration of the AVRD can reduce the turning radius of a vehicle in which an AVRD is installed due to the application of brakes. This reduced turning radius results from the ability of this configuration of the AVRD to produce a reversing action on one wheel while the other continues forward.

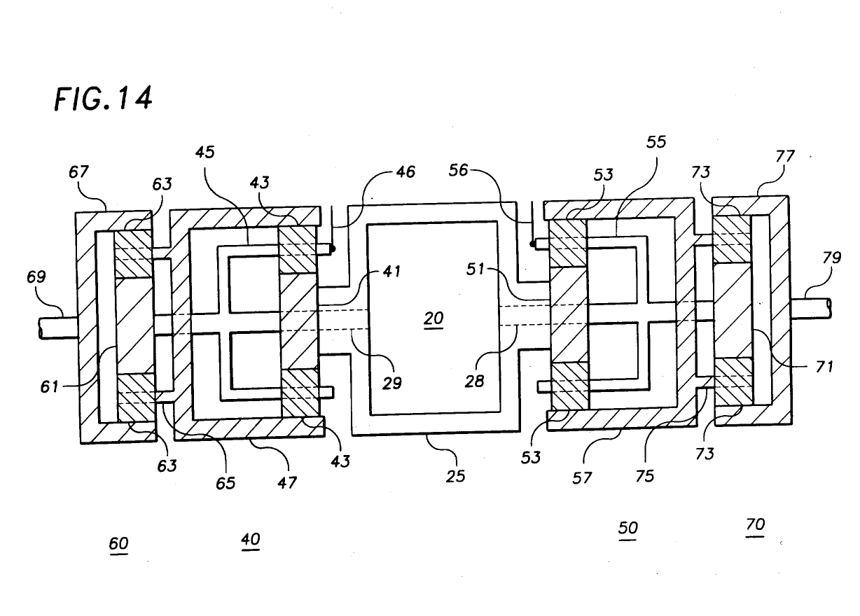

An AVRD can also be used to allow for differentiation of multiple driving wheels in a linear alignment (for example, two wheels on each side of the open differential such as used on heavy trucks). This is accomplished by having a series of planetary gear sets or fixed differentials on each side of the open differential with a wheel attached to each planetary gear set or fixed differential, providing each wheel with independent speed and torque control abilities. Such an arrangement can be made by connecting planetary gear sets or fixed differentials in series, and there are several different ways that the actual connections can be setup, but the schematic in FIG. 14 shows the preferred embodiment. This embodiment is comprised of an open differential 20 and four planetary gear sets 40, 50, 60, and 70. The input from the motor (not shown in the schematic) directs driving torque into the open differential 20. The sun gear 41 which is located in the center of planetary gear set 40 is rigidly attached to the open differential carrier 25 of the open differential 20. The sun gear 41 is orbited by one or more planet gears 43 which make contact with the sun gear 41 with intermeshing teeth. Typically, there are two or three planet gears 43 spaced evenly around the sun gear 41. If there are a plurality of planet gears 43 in planetary gear set 40, then they are rigidly linked together by a planetary carrier 45 which fixes the position of the planet gears 43 relative to one another while allowing each planet gear 43 to rotate about its own center axis. If there is only one planet gear 43 in planetary gear set 40, then the planetary carrier 45, which appears as a connecting arm, links the single planet gear 43 to the center axis of the planetary gear set 40 in order to hold the planet gear 43 in place while allowing the planet gear 43 to rotate about its center axis. A brake 46 attaches to the planetary carrier 45 such that, when the brake 46 is disengaged, it does not affect the rotation of the planetary carrier 45, but when the brake 46 is engaged, it acts to retard the rotation of the planetary carrier 45. The one or more planet gears 43 are encompassed by the annular gear 47 of planetary gear set 40, and the planet gears 43 make contact with the annular gear 47 with intermeshing teeth. The open differential output 29 on this side of the open differential 20 is rigidly attached to the planetary carrier 45 of planetary gear set 40 which is rigidly attached to the sun gear 61 of planetary gear set 60 (the outer planetary gear set on this side). In effect, the open differential output 29 connects first to the planetary carrier 45 of planetary gear set 40 and then extends out beyond planetary gear set 40 and into planetary gear set 60 to connect to the sun gear 61. The sun gear 61 is located in the center of planetary gear set 60 and is encircled by one or more planet gears 63 which make contact with sun gear 61 with intermeshing teeth. Typically, there are two or three planet gears 63 spaced evenly around the sun gear 61. If there are a plurality of planet gears 63 in planetary gear set 60, then they are rigidly linked together by a planetary carrier 65 which fixes the position of the planet gears 63 relative to one another while allowing each planet gear 63 to rotate about its own center axis. If there is only one planet gear 63 in planetary gear set 60, then the planetary carrier 65, which appears as a connecting arm, links the single planet gear 63 to the center axis of the planetary gear set 60 in order to hold the planet gear 63 in place while allowing the planet gear 63 to rotate about its center axis. The planetary carrier 65 of planetary gear set 60 is rigidly attached to the annular gear 47 of planetary gear set 40 (the inner planetary gear set on this side). The one or more planet gears 63 of planetary gear set 60 are encompassed by the annular gear 67 of planetary gear set 60 such that the one or more planet gears 63 make contact with the annular gear 67 with intermeshing teeth. The attachment to the wheels is from each of the annular gears 47 and 67.

The other side of the AVRD is a mirror image of that described above. The sun gear 51 which is located in the center of planetary gear set 50 is rigidly attached to the open differential carrier 25 of the open differential 20. The sun gear 51 is encircled by a one or more planet gears 53 which make contact with the sun gear 51 with intermeshing teeth. Typically, there are two or three planet gears 53 in planetary gear set 50 spaced evenly around the sun gear 51. If there are a plurality of planet gears 53, then they are rigidly linked together by a planetary carrier 55 which fixes the position of the planet gears 53 relative to one another while allowing each planet gear 53 to rotate about its own center axis. If there is only one planet gear 53 in planetary gear set 50, then the planetary carrier 55, which appears as a connecting arm, links the single planet gear 53 to the center axis of the planetary gear set 50 in order to hold the planet gear 53 in place while allowing the planet gear 53 to rotate about its center axis. A brake 56 attaches to the planetary carrier 55 such that, when the brake 56 is disengaged, it does not affect the rotation of the planetary carrier 55, but when the brake 56 is engaged, it acts to retard the rotation of the planetary carrier 55. The one or more planet gears 53 are encompassed by the annular gear 57 of planetary gear set 50, and the planet gears 53 make contact with the annular gear 57 with intermeshing teeth. The open differential output 28 on this side of the open differential 20 is rigidly attached to the planetary carrier 55 of planetary gear set 50 which is rigidly attached to the sun gear 71 of planetary gear set 70 (the outer planetary gear set on this side). In effect, the open differential output 28 connects first to the planetary carrier 55 of planetary gear set 50 and then extends out beyond planetary gear set 50 and into planetary gear set 70 to connect to the sun gear 71. The sun gear 71 is located in the center of planetary gear set 70 and is orbited by one or more planet gears 73 which make contact with sun gear 71 with intermeshing teeth. Typically, there are two or three planet gears 73 spaced evenly around the sun gear 71. If there are a plurality of planet gears 73 in planetary gear set 70, then they are rigidly linked together by a planetary carrier 75 which fixes the position of the planet gears 73 relative to one another while allowing each planet gear 73 to rotate about its own center axis. If there is only one planet gear 73 in planetary gear set 70, then the planetary carrier 75, which appears as a connecting arm, links the single planet gear 73 to the center axis of the planetary gear set 70 in order to hold the planet gear 73 in place while allowing the planet gear 73 to rotate about its center axis. The planetary carrier 75 of planetary gear set 70 is rigidly attached to the annular gear 57 of planetary gear set 50 (the inner planetary gear set on this side). The one or more planet gears 73 of planetary gear set 70 are encompassed by the annular gear 77 of planetary gear set 70 such that the planet gears 73 make contact with the annular gear 77 with intermeshing teeth. The attachment to the wheels is from each of the annular gears 57 and 77. This configuration of the AVRD can reduce the turning radius of a vehicle in which an AVRD is installed due to the application of brakes. This reduced turning radius results from the ability of this configuration of the AVRD to produce a reversing action on one wheel while the other continues forward.

In all configurations of the AVRD, an internal open differential carrier can be used instead of the external open differential carrier which is more commonly used. An example of such an embodiment using an internal open differential carrier is shown in the schematic labeled FIG. 15. This preferred embodiment is comprised of an open differential 20 and two planetary gear sets 40 and 50. The input from the motor (not shown in the schematic) directs driving torque into the open differential 20. On one side of the open differential 20, the sun gear 41 which is located at the center of planetary gear set 40 is rigidly attached to the internal open differential carrier 25. The sun gear 41 is encircled by one or more planet gears 43 which contact the sun gear 41 with intermeshing teeth. Typically, there are two or three planet gears evenly spaced about the sun gear 41. If there are a plurality of planet gears 43 in planetary gear set 40, then they are rigidly linked together by a planetary carrier 45 which fixes the positions of the planet gears 43 relative to one another while allowing each of the planet gears 43 to rotate about its own center axis. If there is only one planet gear 43 in planetary gear set 40, then the planetary carrier 45, which appears as a connecting arm, links the single planet gear 43 to the center axis of the planetary gear set 40 in order to hold the planet gear 43 in place while allowing the planet gear 43 to rotate about its center axis. The planetary carrier 45 of planetary gear set 40 is rigidly attached to the open differential output 29 and also to a brake 46. When the brake 46 is disengaged, it does not affect the rotation of the planetary carrier 45, but when the brake 46 is engaged, it acts to retard the rotation of the planetary carrier 45. The one or more planet gears 43 of planetary gear set 40 are encompassed by the annular gear 47 of the planetary gear set 40, and the one or more planet gears 43 make contact with the annular gear 47 with intermeshing teeth. The annular gear 47 is rigidly attached to the planetary gear set output 49 of planetary gear set 40.

The other side of the AVRD is a mirror image of that described above. The sun gear 51 which is located at the center of planetary gear set 50 is rigidly attached to the internal open differential carrier 25. The sun gear 51 is orbited by one or more planet gears 53 which contact the sun gear 51 with intermeshing teeth. Typically, there are two or three planet gears 53 evenly spaced about the sun gear 51. If there are a plurality of planet gears 53 in planetary gear set 50, then they are rigidly linked together by a planetary carrier 55 which fixes the positions of the planet gears 53 relative to one another while allowing each of the planet gears 53 to rotate about its own center axis. If there is only one planet gear 53 in planetary gear set 50, then the planetary carrier 55, which appears as a connecting arm, links the single planet gear 53 to the center axis of the planetary gear set 50 in order to hold the planet gear 53 in place while allowing the planet gear 53 to rotate about its center axis. The planetary carrier 55 of planetary gear set 50 is rigidly attached to the open differential output 28 and also to a brake 56. When the brake 56 is disengaged, it does not affect the rotation of the planetary carrier 55, but when the brake 56 is engaged, it acts to retard the rotation of the planetary carrier 55. The one or more planet gears 53 of planetary gear set 50 are encompassed by the annular gear 57 of the planetary gear set 50, and the one or more planet gears 53 make contact with the annular gear 57 with intermeshing teeth. The annular gear 57 is rigidly attached to the planetary gear set output 59 of planetary gear set 50. This configuration of the AVRD can reduce the turning radius of a vehicle in which an AVRD is installed due to the application of brakes. This reduced turning radius results from the ability of this configuration of the AVRD to produce a reversing action on one wheel while the other continues forward.

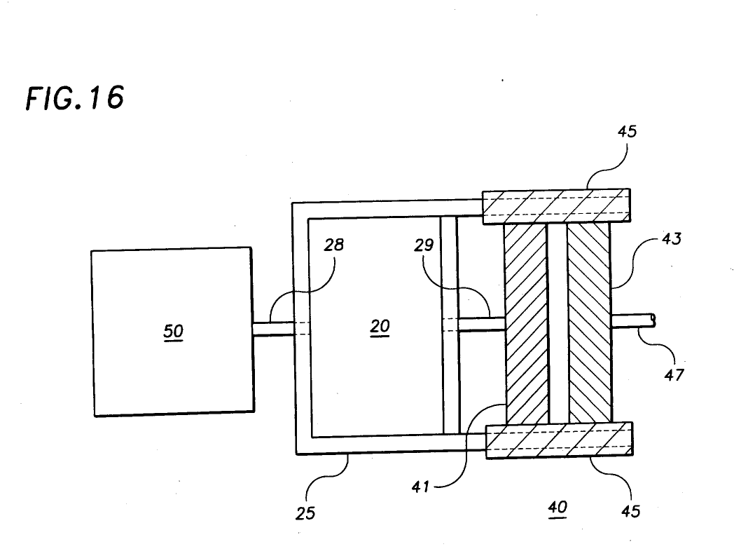

The AVRD can also be made to function as a transmission for a vehicle by altering its configuration. One method for doing this involves replacing one of the planetary gear sets or fixed differentials with a variable speed motor. The planetary gear set or fixed differential which is used in this arrangement can be connected to the open differential in any of the configurations described above. The schematic in FIG. 16 shows the preferred embodiment for this arrangement. This embodiment is comprised of an open differential 20, a fixed differential 40, and a variable speed motor 50. The variable speed motor 50 is rigidly attached to the open differential output 28 on one side of the open differential 20. On the other side of the open differential 20, the open differential output 29 is rigidly attached to the inner gear 41 of the fixed differential 40 (typically, it is a gear of the annular type, the spur type, or the bevel type). Facially adjacent to but not in contact with the inner gear 41 is the outer gear 43 of the fixed differential 40 (which is of the same gear type as the inner gear 41). The outer gear 43 has more teeth than does the inner gear 41. One or more planet gears 45 link the inner gear 41 and the outer gear 43 of the fixed differential 40 by tangentially contacting both with intermeshing teeth. The one or more planet gears 45 are rigidly attached to the open differential carrier 25. Typically, there are two or three planet gears 45 spaced evenly around the inner gear 41 and the outer gear 43. If there a plurality of planet gears 45 in fixed differential 40, then the positions of the planet gears 45 are fixed relative to one another and relative to the open differential carrier 25 while allowing each planet gear 45 to rotate about its own center axis. If there is only one planet gear 45 in fixed differential 40, then its position is fixed relative to the open differential carrier 25 while it is allowed to rotate about its center axis, and it is held in contact with the inner gear 41 and outer gear 43. The fixed differential output 47 is rigidly attached to the outer gear 43 of the fixed differential 40.

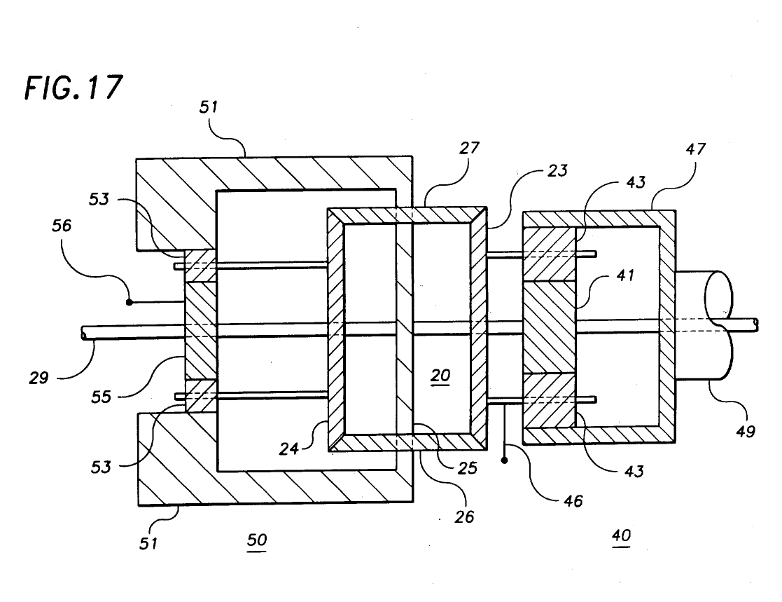

Yet another preferred embodiment in which the AVRD can be used as a transmission is shown in the schematic labeled FIG. 17. On one side of the open differential 20, the sun gear 55 is located in the center of planetary gear set 50. A brake 56 attaches to the sun gear 55 such that, when disengaged, it does not affect the rotation of the sun gear 55, but when engaged, it acts to retard the rotation of sun gear 55. Orbiting sun gear 55 in planetary gear set 50 and in contact with sun gear 55 (with intermeshing teeth) are one or more planet gears 53. Typically, there are two or three planet gears 53 evenly spaced around the sun gear. These planet gears 53 are rigidly attached to the side bevel gear 24 of the open differential 20 such that the positions of the planet gears 53 are fixed relative to each other and relative to the side bevel gear 24 while allowing each planet gear 53 to rotate about its own center axis. The one or more planet gears 53 are encompassed by the annular gear 51 of planetary gear set 50 and are in contact with the annular gear 51 (with intermeshing teeth). The annular gear 51 is rigidly attached to the carrier cross 25 of the open differential 20. The carrier cross 25 passes through the open differential planet gears 26 and 27, and the carrier cross 25 also passes through the input shaft 29 of the open differential 20. Thus, when the input shaft 29 rotates, it causes the carrier cross 25 to move with it, and this causes the annular gear 51 of the planetary gear set 50 to rotate. The input shaft 29 passes through the side bevel gear 23 of the open differential 20 and connects (either rigidly or with keyed teeth) to the sun gear 41 of planetary gear set 40. Sun gear 41 is encircled by one or more planet gears 43 which make contact with sun gear 41 (with intermeshing teeth). Typically, there are two or three planet gears 43 spaced evenly about the sun gear 41. The planet gears 43 are rigidly attached to the side bevel gear 23 of the open differential 20 such that the positions of the planet gears 43 are fixed relative to one another and relative to the side bevel gear 23 while allowing each planet gear 43 to rotate about its own center axis. A brake 46 is attached to the side bevel gear 23 such that, when it is disengaged, the rotation of the side bevel gear 23 is not affected, but when the brake 46 is engaged, it acts to retard the rotation of the side bevel gear 23 and the planet gears 43. Encompassing the one or more planet gears 43 of planetary gear set 40 is the annular gear 47. The annular gear 47 makes contact on its inner surface (with intermeshing teeth) with the one or more planet gears 43. Rigidly attached to the annular gear 47 is the transmission output 49 (which is typically a shaft).

### INDUSTRIAL APPLICABILITY

The AVRD represents an improvement in vehicle differentials. Due to the widespread use of motorized vehicles (which incorporate differentials), the AVRD can have a broad impact industrially. In particular, it helps vehicles avoid becoming stuck in mud or ice. Thus, the AVRD is of benefit in any type of wheeled transportation industry, such as cargo transporting via trucks. Besides allowing such transportation to continue under severe conditions, the AVRD is also more durable than the limited-slip differentials currently used, so maintenance delays should be reduced. In addition, the AVRD allows for a much tighter vehicle turning radius in many of its configurations. This feature is particularly useful when vehicles are required to maneuver in close and confined quarters, such as forklifts moving items inside a warehouse. Because the vehicles which can benefit from the AVRD are used throughout many industries, the AVRD's industrial impact could be quite substantial.

What we claim is:

1. An automatic variable ratio differential comprising:
an open differential,
a first planetary gear set, and
a second planetary gear set,
said open differential further comprising:
an open differential carrier,
a first open differential side output, and
a second open differential side output;
said first planetary gear set further comprising three elements, wherein said three elements are further comprised of a sun gear, an annular gear, and a planet gear array;
said second planetary gear set further comprising three elements, wherein said three elements are further comprised of a sun gear, an annular gear, and a planet gear array; and
said planet gear array of said first planetary gear set and said planet gear array of said second planetary gear set are each further comprised of one or more planet gears and a planetary carrier;
wherein said elements of said first planetary gear set match said elements of said second planetary gear set;
said first element of said first planetary gear set is rigidly attached to said first open differential side output, and said matching element of said second planetary gear set is rigidly attached to said second open differential side output; and
said second element of said first planetary gear set is rigidly attached to said open differential carrier, and said matching element of said second planetary gear set is rigidly attached to said open differential carrier.

2. An automatic variable ratio differential as in claim 1 further comprising a first output shaft and a second output shaft, wherein said third element of said first planetary gear set is rigidly attached to said first output shaft and said matching element of said second planetary gear set is rigidly attached to said second output shaft; wherein each of said elements of said first planetary gear set are rigidly attached to only one of said open differential carrier, said first open differential side output, or said first output shaft; and wherein each of said elements of said second planetary gear set are rigidly attached to only one of said open differential carrier, said second open differential side output, or said second output shaft.

3. An automatic variable ratio differential as in claim 2, wherein each of said elements of said first planetary gear set do not rigidly attach directly to any of said elements of said second planetary gear set.

4. An automatic variable ratio differential as in claim 1 wherein:
said sun gear of said first planetary gear set and said sun gear of said second planetary gear set are substantially the same size and have substantially the same number of teeth;
said annular gear of said first planetary gear set and said annular gear of said second planetary gear set are substantially the same size and have substantially the same number of teeth; and
said one or more planet gears of said first planetary gear set and said one or more planet gears of said second planetary gear set are substantially the same size and have substantially the same number of teeth.

5. An automatic variable ratio differential as in claim 1 wherein:
said sun gear of said first planetary gear set is rigidly attached to said open differential carrier;
said sun gear of said second planetary gear set is rigidly attached to said open differential carrier;
said one or more planet gears of said first planetary gear set are linked to said first open differential side output such that said one or more planet gears of said first planetary gear set are free to rotate about their axes, but such that the axes of said one or more planet gears of said first planetary gear set are rigidly attached to said first open differential side output; and
said one or more planet gears of said second planetary gear set are linked to said second open differential side output such that said one or more planet gears of said second planetary gear set are free to rotate about their axes, but such that the axes of said one or more planet gears of said second planetary gear set are rigidly attached to said second open differential side output.

6. An automatic variable ratio differential as in claim 5 wherein:
said sun gear of said first planetary gear set and said sun gear of said second planetary gear set are substantially the same size and have substantially the same number of teeth;
said annular gear of said first planetary gear set and said annular gear of said second planetary gear set are substantially the same size and have substantially the same number of teeth; and
said one or more planet gears of said first planetary gear set and said one or more planet gears of said second planetary gear set are substantially the same size and have substantially the same number of teeth.

7. An automatic variable ratio differential as in claim 5 further comprising a brake-clutch mechanism.

8. An automatic variable ratio differential as in 6 further comprising two brake-clutch mechanisms, wherein one of said brake-clutch mechanisms may act to restrain the rotation of said one or more planet gears of said first planetary gear set with respect to said sun gear of said first planetary gear set, and the other of said brake-clutch mechanisms may act to restrain the rotation of said one or more planet gears of said second planetary gear set with respect to said sun gear of said second planetary gear set.

9. An automatic variable ratio differential as in claim 5 wherein each of said planetary gear arrays further comprises multiple layers of planet gears.

10. An automatic variable ratio differential as in claim 8 wherein each of said planetary gear arrays further comprises multiple layers of planet gears.

11. An automatic variable ratio differential as in claim 8 further comprising two output shafts, wherein said first output shaft is rigidly attached to said annular gear of said first planetary gear set and said second output shaft is rigidly attached to said annular gear of said second planetary gear set.

12. An automatic variable ratio differential as in claim 11 further comprising two wheels, wherein each of said output shafts transmits driving torque to one of said wheels.

13. An automatic variable ratio differential as in claim 10 further comprising two output shafts, wherein said first output shaft is rigidly attached to said annular gear of said first planetary gear set and said second output shaft is rigidly attached to said annular gear of said second planetary gear set.

14. An automatic variable ratio differential as in claim 13 further comprising two wheels, wherein each of said output shafts transmits driving torque to one of said wheels.

15. An automatic variable ratio differential comprising:
an open differential,
a first planetary gear set,
a second planetary gear set,
a first output shaft, and
a second output shaft;
said open differential further comprising:
an open differential carrier,
a first open differential side output, and
a second open differential side output;
said first planetary gear set further comprising three elements, wherein said three elements are further comprised of a sun gear, an annular gear, and a planet gear array;
said second planetary gear set further comprising three elements, wherein said three elements are further comprised of a sun gear, an annular gear, and a planet gear array; and
said planet gear array of said first planetary gear set and said planet gear array of said second planetary gear set are each further comprised of one or more planet gears and a planetary carrier;
wherein said elements of said first planetary gear set match said elements of said second planetary gear set;
said sun gear of said first planetary gear set is rigidly attached to said open differential carrier;
said sun gear of said second planetary gear set is rigidly attached to said open differential carrier;
said planetary carrier of said first planetary gear set is rigidly attached to said first open differential side output;
said planetary carrier of said second planetary gear set is rigidly attached to said second open differential side output;
said first output shaft is rigidly attached to said annular gear of said fist planetary gear set and said second output shaft is rigidly attached to said annular gear of said second planetary gear set;
said sun gear of said first planetary gear set and said sun gear of said second planetary gear set are substantially the same size and have substantially the same number of teeth;
said annular gear of said first planetary gear set and said annular gear of said second planetary gear set are substantially the same size and have substantially the same number of teeth; and
said one or more planet gears of said first planetary gear set and said one or more planet gears of said second planetary gear set are substantially the same size and have substantially the same number of teeth.

16. An automatic variable ratio differential as in claim 15 further comprising two brakes, wherein one of said brakes may act to restrain the rotation of said one or more planet gears of said first planetary gear set with respect to said sun gear of said first planetary gear set, and the other of said brakes may act to restrain the rotation of said one or more planet gears of said second planetary gear set with respect to said sun gear of said second planetary gear set.

17. An automatic variable ratio differential as in claim 15 wherein each of said elements of said first planetary gear set are rigidly attached to only one of said open differential carrier, said first open differential side output, or said first output shaft; and wherein each of said elements of said second planetary gear set are rigidly attached to only one of said open differential carrier, said second open differential side output, or said second output shaft.

18. An automatic variable ratio differential as in claim 17 wherein each of said elements of said first planetary gear set do not rigidly attach directly to any of said elements of said second planetary gear set.

19. An automatic variable ratio differential as in claim 16 wherein each of said elements of said first planetary gear set are rigidly attached to only one of said open differential carrier, said first open differential side output, or said first output shaft; and wherein each of said elements of said second planetary gear set are rigidly attached to only one of said open differential carrier, said second open differential side output, or said second output shaft.

20. An automatic variable ratio differential as in claim 19 wherein each of said elements of said first planetary gear set do not rigidly attach directly to any of said elements of said second planetary gear set.
